(19) United States
(12) Patent Application Publication
(10) Pub. No.: US 2004/0091777 A1
(43) Pub. Date: May 13, 2004

(54) Lead compositions for lead-acid batteries

(75) Inventors: Lan Trieu Lam, Springvale (AU); David Anthony Rand, Beaumaris (AU)

Correspondence Address: MERCHANT & GOULD PC, P.O. BOX 2903, MINNEAPOLIS, MN, 55402-0903, US

(73) Assignees: COMMONWEALTH SCIENTIFIC AND INDUSTRIAL RESEARCH ORGANISATION, Campbell (AU); INTERNATIONAL LEAD ZINC RESEARCH ORGANIZATION, INC.

(21) Appl. No.: 10/658,841

(22) Filed: Sep. 8, 2003

(30) Foreign Application Priority Data
Oct. 24, 2002 (AU) 2002952234

(51) Int. Cl. H01M 4/56; H01M 4/38; C22C 11/00

(52) U.S. Cl. 429/225; 429/228; 252/182.1; 420/566

(57) ABSTRACT

Lead composition for use in the production of battery components particularly the electrode plates, having specific amounts or ranges of trace elements to maximise battery life. Ranges of trace elements include the combination of 20-100 ppm silver, 250-1000 ppm bismuth, and 250-1000 ppm zinc; or 100-1000 ppm antimony and 100-1000 ppm iron; or 250-1000 ppm bismuth, 250-1000 ppm zinc, 20-100 ppm silver, not more than 20 ppm antimony and not more than 30 ppm iron.

The present invention relates to lead acid batteries, and to pastes and the lead compositions used to make pastes that coat the grids which form the positive and negative plates of the battery.

Lead-batteries generally include a number of cell elements which are encased in separate compartments of a battery case containing sulphuric acid electrolyte. Each cell element includes at least one positive plate, at least one negative plate, and a porous separator (or “envelope”) positioned between each positive and negative plate. The positive and negative plates are each made up of a metal grid (usually lead or a lead alloy) that supports an electrochemically active material which is “pasted” onto the grid. The active material is a lead-based material. Depending on the different charge/discharge state of the battery, the active material is in the form of lead dioxide and/or lead sulfate at the positive plate, and sponge lead and/or lead sulphate at the negative plate.

The paste for application to the metal grid is generally prepared by mixing lead oxide (also containing some lead particles), water and sulphuric acid. Other additives may also be included in the paste mixture. Common additives for pastes to be applied to grids for forming the positive plate include glass fibre and carboxymethyl cellulose, and common additives for pastes to be applied to grids for forming negatives plates include carbon, barium sulphate and lignosulphonates. The paste is applied to lead grid, and the pasted plates are typically cured under control temperature and humidity conditions. Thereafter, the cured and dried plates are assembled in their compartments of the battery case with the addition of acid, and a current is passed therethrough to “form” the battery. During the formation stage, the lead sulphate or basic lead sulphate(s) are converted to lead dioxide at the positive plates, and to sponge lead at the negative plates.

The lead oxide used in forming the paste for applying to the grid is frequently made in one of two standard methods, the Barton pot and the ball mill method. In each method, pure lead is oxidised by air at elevated temperature and under high sheer conditions to form a fine lead oxide powder.

The raw lead material used for forming the oxide frequently contains many residual elements. Indeed, the complete removal of impurities from lead is prohibitively expensive, and therefore the lead oxide used to form the paste (which also contains small amounts of unoxidised lead) also includes these impurity elements in either or both of the free metal and oxide form.

There are two major classes of lead acid batteries—valve regulated lead acid batteries and flooded lead acid batteries. Valve regulated lead acid (VRLA) batteries have the general construction described above and are increasingly replacing conventional flooded batteries in stationery applications. Common applications for the use of VRLA batteries are telecommunications and uninterruptible power-supply systems. VRLA batteries do not require water maintenance. Although VRLA batteries are designed to have a life of twenty years it has been found that, in reality, the life of such batteries is much shorter than this. The main failure modes of these batteries include dry-out and thermal runaway, selective discharge of negative or positive plates, heavy grid corrosion, and positive-plate failure. While there are several possible causes for a given failure mode, it is clear that impurity elements in the lead oxide used in the paste coatings of the plates exert a strong influence on all failure modes through gassing effects.

The “gassing effect” is the phenomenon of release of oxygen at the positive plate of the battery, and hydrogen at the negative plate of the battery during charging of the battery. In an ideal world, no oxygen and hydrogen would be evolved at the positive and negative plates, however, in reality, towards the end of the charging process, oxygen and hydrogen are evolved from these plates. Oxygen and hydrogen are evolved through side reactions during the conversion of lead sulphate to lead dioxide (at the positive plate) and sponge lead (at the negative plate). It has been found that the level of impurity elements in the lead/lead oxide used during formation of the paste coating greatly influences the level of oxygen and hydrogen evolution.

The present applicants identified a need to study the influence of impurity or “residual” elements in lead on gassing rates to enable the gassing rates to be controlled within safe limits to improve the life of lead acid batteries, such as VRLA batteries.

The present applicants designed a comprehensive study to identify those elements present in lead which give rise to appreciable hydrogen and/or oxygen gassing and which, therefore, must be restricted or avoided as harmful elements. On the other hand, it was recognised that some elements could enhance battery performance, and therefore be considered beneficial elements. The applicant examined the influence of Ag, As, Bi, Cd, Co, Cr, Cu, Fe, Ge, Mn, Ni, Sb, Se, Sn, Te, Zn and later Tl, since there appeared to be little information available in the literature on the influence of this element on gassing rates. Some of the elements examined in the study may not be present in the lead produced by some manufacturers. Nevertheless, many of these elements are likely to occur in “secondary lead”—the major resource for lead-acid battery production in the future.

It is noted that standards have been set by some countries, for recommended “acceptable levels” (ALs) for certain residual elements present in lead when used in batteries. However, the majority of standards define ALs for lead to be used in batteries which employ antimonial alloy grids. In these designs, the antimony in the positive and negative grids dominates the performance of the battery so that the influence of residual elements (either harmful or beneficial elements) is of little importance. In contrast, VRLA and flooded lead acid batteries employ grids such as lead-calcium-tin and lead-tin with or without the incorporation of silver, to increase the corrosion resistance of the grid. As a consequence, some elements that are anticipated to be harmful to varying extents in lead acid batteries (which do not employ antimonial grids) have not been included in the existing standards.

Especially in the context of VRLA technologies, it is important to understand the maximum acceptable levels for silver and tin in lead to be used for producing VRLA batteries. For example, silver can reduce the rate of production of leady oxide via the Barton-pot process by up to 10%. It is also very costly to remove low levels of silver from secondary lead. Given these considerations, it is believed by the present applicant to be important to determine the maximum acceptable levels of all residual elements, and especially silver and tin, in lead for use in the manufacture of lead acid batteries, such as VRLA batteries.

As a consequence, it is an objective of the present invention to arrive at lead compositions, paste compositions, and batteries formed therefrom, which improve the life and/or reduce the costs of lead acid batteries, including valve regulated lead acid batteries.

The present applicant has arrived at two general classes of specifications, depending on whether the same lead composition or lead-based paste is used in producing both the positive and negative plates, or whether different compositions are used for each of the positive and negative plates. Both of the compositions have been determined from the results of the study.

The first aspect of the present invention relates to a specification for use in producing positive and negative plates using the same preliminary lead oxide material.

According to this aspect, there is provided a lead composition for use in the production of battery components, the lead composition comprising

20-100 ppm silver

250-1000 ppm bismuth, and

250-1000 ppm zinc.

It has been found by the present applicant that this particular combination of elements, when present in the lead composition applied to negative battery grids at the defined levels, surprisingly mask or suppress the production of H₂ to such an extent that the float current for the battery remains below the critical value, thereby enabling the battery to operate effectively for a full 20 years.

The lead is present in a major proportion (so as to enable the composition to be considered a “lead-based composition”). The lead may be in free metal or oxide form, or in a mixture of forms. The particular form of the lead will depend on its stage of manufacture, and the point in the manufacturing process at which the elements silver, bismuth and zinc are added. If added to the “pure lead” prior to the oxide production stage, the lead in this case will be in the form of the free metal. If added after the lead is converted to the oxide, the lead will be predominantly in the form of lead oxide, with some free lead.

The residual elements/additives silver, bismuth and zinc may likewise be present in a free metal form, or as a compound with one or more other elements. For example, the zinc may be added in the form of zinc oxide, zinc sulphide or otherwise. If added as a free metal before the lead composition is subjected to oxidation, the residual elements/additives will be similarly oxidised. The amounts expressed in parts per million are measured as ppm of the element, whether it is free metal or other form. The amount can be measured by inductively coupled plasma atomic emissions spectroscopy (IPC-AES).

According to a preferred embodiment of the first aspect, the level of bismuth in the lead composition is between 250-700 ppm, and more preferably 250-500. Similarly, according to another embodiment, the level of zinc in the lead composition is preferably between 250-700 ppm and more preferably 250-500 ppm. According to a further embodiment, preferably the level of silver is between 20-70 ppm, and most preferably 20-66 ppm.

The applicant has additionally found that cadmium also assists to mask or suppress gassing. Producers may elect not to include this heavy metal in the lead composition for health purposes, however it is advantageous to include it at a level of from 0-1000 ppm, preferably 0-700 ppm, and more preferably 0-500 ppm. Optionally, it may be present at a minimum level of 20 ppm or 50 ppm (with either of the upper limits) to obtain the benefits associated with this element.

According to another embodiment of the first aspect, the lead composition also includes tin at a level of 5-80 ppm, preferably 5-40 ppm. According to this embodiment, tin is preferably present in the composition at a level of at least 5 ppm, and optionally at least 25 ppm.

The present applicant has found that, if the three elements silver, bismuth and zinc (and optionally cadmium and optionally tin) are included in the lead composition at the broadly described levels, other impurity elements frequently found in lead (and usually removed or substantially reduced to minimise problems) can be retained in the lead composition at levels that are quite distinct from the levels at which they are currently present.

According to one embodiment, preferably the lead composition contains not more than 10 ppm cobalt, 15 ppm chromium, 5 ppm manganese, 3 ppm selenium, 5 ppm tellurium, 250 ppm germanium, and 20 ppm thallium. Preferably, the lead composition contains not more than 10 ppm nickel, 10 ppm antimony, 20 ppm iron, 20 ppm copper and 20 ppm arsenic.

More preferably, according to this embodiment, the lead composition contains not more than 2 ppm cobalt, 4 ppm chromium, 1.5 ppm manganese, 0.5 ppm selenium, 0.15 ppm tellurium, 10 ppm germanium, and 12 ppm thallium. More preferably, the lead composition contains not more than 2 ppm nickel, 2 ppm antimony, 5 ppm iron, 5 ppm copper and 4 ppm arsenic.

In summary, according to one embodiment, the broader specification for the lead composition is such that the lead composition preferably comprises

lead;

silver, bismuth, zinc and tin in the following amounts:

| | |
|---|---|
| Ag | 20-100 ppm |
| Bi | 250-1000 ppm |
| Zn | 250-1000 ppm |
| Sn | 5-80 ppm |

and not more than the given amounts of the following elements measured in ppm:

| | |
|---|---|
| Ni | 10 |
| Sb | 10 |
| Co | 10 |
| Cr | 15 |
| Fe | 20 |
| Mn | 5 |
| Cu | 20 |
| Se | 3 |
| Te | 5 |
| As | 20 |
| Ge | 250 |
| Tl | 20 |
| Cd | 1000. |

For the “broad specification” set out above, preferably the composition contains not more than the following amounts for at least 8, and more preferably at least 10 of the 13 elements set out in the following list:

| | |
|---|---|
| Ni | 2 |
| Sb | 2 |
| Co | 2 |
| Cr | 4 |
| Fe | 5 |
| Mn | 1.5 |
| Cu | 5 |
| Se | 0.5 |
| Te | 0.15 |
| As | 4 |
| Ge | 10 |
| Tl | 12 |
| Cd | 700. |

By way of explanation, provided that at least 8 or preferably 10 of the list of 13 elements above are not present in the composition above the levels defined above, then the other 5 or 3 elements may be present above these levels (but not above the broader maximums) without significant disadvantage.

In summary, the narrower specification for the lead composition is such that the lead composition preferably comprises

lead;

silver, bismuth, zinc and tin in the following amounts:

| | |
|---|---|
| Ag | 20-70 ppm |
| Bi | 250-700 ppm |
| Zn | 250-700 ppm |
| Sn | 5-40 ppm |

and not more than the given amounts of the following elements measured in ppm:

| | |
|---|---|
| Ni | 2 |
| Sb | 2 |
| Co | 2 |
| Cr | 4 |
| Fe | 5 |
| Mn | 1.5 |
| Cu | 5 |
| Se | 0.5 |
| Te | 0.15 |
| As | 4 |
| Ge | 10 |
| Tl | 12 |
| Cd | 700. |

The lead composition defined above may be in the form of a lead metal in any form, such as pellet form, a lead oxide powder, a lead-containing paste or a cured lead coating.

The present invention also provides a battery plate having a coating of any of the compositions as described above, together with any other optional additives found in battery plate coatings. Possible additives are well known in the art of the invention, and include glass fibre, carboxymethyl cellulose, carbon, barium sulphate and lignosulphonates as some examples.

Furthermore, the present invention also provides a battery containing components having or including the lead composition described above, or one or more battery plates as described above.

It has also been found by the present applicant that the particular combination of elements such antimony and iron, when present in the lead composition applied to positive battery grids at the defined levels, mask or suppress the production of O₂.

According to a second aspect there are provided two separate lead compositions, one being suitable for use in the production of positive plates (specifically, the coating applied to a positive plate grid) the other being suitable for use in the production of negative plates for lead acid batteries.

In one embodiment, the lead composition suitable for use in the production of positive plates comprises:

lead

100-1000 ppm antimony

100-1000 ppm iron.

Preferably, the lead composition suitable for use in coating positive plates contains less than 700 ppm zinc and preferably between 250-700 ppm bismuth and 250-700 ppm zinc. The preferred maximum amounts of other elements are the same as those set out above for the lead composition of the first aspect of the invention.

Iin another embodiment, the lead composition suitable for use in the production of negative plates comprises:

lead

250-1000 ppm bismuth

250-1000 ppm zinc and

20-100 ppm silver,

and not more than 20 ppm antimony and not more than 30 ppm iron.

Preferably, the level of bismuth is 250-700 ppm, and the level of silver is 20-70 ppm, more preferably 40-66 ppm. Preferably, the level of antimony and iron in the lead composition for use in coating negative plates is not more than 2 ppm antimony and 5 ppm iron. Preferably, aside from the elements bismuth, zinc, silver, iron and antimony, the levels of the other residual elements in the iron composition are the same as those set out above for the lead compositions of the first aspect of the present invention.

In summary, according to one “positive plate composition” embodiment, the lead composition for use in the production of pastes for positive plates preferably broadly comprises

lead;

100-1000 ppm antimony

100-1000 ppm iron;

and not more than the given amounts of the following elements, measured in ppm:

| | |
|---|---|
| Bi | 1000 |
| Zn | 1000 |
| Cd | 1000 |
| Sn | 80 |
| Ni | 10 |
| Co | 10 |
| Cr | 15 |
| Mn | 5 |
| Cu | 20 |
| Ag | 100 |
| Se | 3 |
| Te | 5 |
| As | 20 |
| Ge | 250 |
| Tl | 20. |

Preferably the composition contains not more than the following amounts for at least 10, and more preferably at least 12 of the elements set out in the following list:

| | |
|---|---|
| Bi | 700 |
| Zn | 700 |
| Cd | 500 |
| Sn | 50 |
| Ni | 2 |
| Co | 2 |
| Cr | 4 |
| Mn | 1.5 |
| Cu | 5 |
| Ag | 66 |
| Se | 0.5 |
| Te | 0.15 |
| As | 4 |
| Ge | 10 |
| Tl | 12. |

According to another embodiment, the lead composition for use in the production of pastes for positive plates optimally comprises:

lead;

100-1000 ppm antimony

100-1000 ppm iron;

and not more than the given amounts of the following elements, measured in ppm:

| | |
|---|---|
| Bi | 700 |
| Zn | 700 |
| Cd | 500 |
| Sn | 50 |
| Ni | 2 |
| Co | 2 |
| Cr | 4 |
| Mn | 1.5 |
| Cu | 5 |
| Ag | 66 |
| Se | 0.5 |
| Te | 0.15 |
| As | 4 |
| Ge | 10 |
| Tl | 12. |

In summary, according to one “negative plate composition” embodiment, the lead composition for use in the production of pastes for negative plates preferably broadly comprises

lead;

250-1000 ppm Bi

250-1000 ppm Zn

20-100 ppm Ag

and not more than the given amounts of the following elements measure in ppm:

| | |
|---|---|
| Sb | 10 |
| Fe | 20 |
| Sn | 80 |
| Cd | 1000 |
| Ni | 10 |
| Co | 10 |
| Cr | 15 |
| Mn | 5 |
| Cu | 20 |
| Se | 3 |
| Te | 5 |
| As | 20 |
| Ge | 250 |
| Tl | 20. |

Preferably the composition contains not more than the following amounts for at least 9, and more preferably at least 11 of the 14 elements set out in the following list:

| | |
|---|---|
| Sb | 2 |
| Fe | 5 |
| Sn | 50 |
| Cd | 500 |
| Ni | 2 |
| Co | 2 |
| Cr | 4 |
| Mn | 1.5 |
| Cu | 5 |
| Se | 0.5 |
| Te | 0.15 |
| As | 4 |
| Ge | 10 |
| Tl | 12. |

According to another embodiment, the lead composition for use in the production of pastes for negative plates optimally comprises

lead;

250-700 ppm Bi

250-1000 ppm Zn

40-66 ppm Ag

and not more than the given amounts of the following elements measure in ppm:

| | |
|---|---|
| Sb | 2 |
| Fe | 5 |
| Sn | 50 |
| Cd | 500 |
| Ni | 2 |
| Co | 2 |
| Cr | 4 |
| Mn | 1.5 |
| Cu | 5 |
| Se | 0.5 |
| Te | 0.15 |
| As | 4 |
| Ge | 10 |
| Tl | 12 |

The lead compositions defined above (for positive and negative plates) may be in the form of a lead metal in any form, such as pellet form, a lead oxide powder, a lead-containing paste or a cured lead coating.

The present specification also provides a positive battery plate having a coating containing the positive paste composition described above, and a negative battery plate having a coating containing the negative paste composition described above.

In the lead compositions of the prior art, testing has not been conducted on the levels of cobalt, chromium, manganese, selenium, tellurium, germanium and thallium. It has been found by the present applicant, however, that the control of these elements in various embodiments within certain maximum acceptable levels leads to improvements in the battery life.

Accordingly, there is also provided a method for monitoring the level of undesirable elements in a lead composition, comprising the steps of:

(a) selecting maximum acceptable levels for the elements cobalt, chromium, manganese, selenium, tellurium, germanium and thallium in a lead composition;

(b) testing the level of said elements in a lead composition;

(c) evaluating the results of the test to determine whether the levels of the elements are within the selected maximum acceptable levels; and

(d) optionally modifying the lead composition to bring the level of any of the elements that are outside the maximum acceptable levels within the maximum acceptable levels.

Preferably, step (b) involves testing the level of said elements using inductively coupled plasma atomic emission spectroscopy.

Preferably, the method further comprises the steps of

selecting the required levels or maximum acceptable levels of the elements tin, bismuth, zinc, cadmium, nickel, antimony, iron, copper, silver and arsenic in a lead composition;

testing the level of these elements;

evaluating the results of the test to determine whether the levels of the elements are within the required levels or maximum acceptable levels; and

optionally modifying the lead composition to bring the level of any of the elements that are outside the required levels or maximum acceptable levels within these levels.

Overall Strategy

In order to achieve the above objective, an overall strategy was formulated to focus on the following four areas.

(i) It was necessary to identify and to determine the safe limits to enable the lead acid battery to have a 20 year life. The safe limits are the critical values of float, hydrogen and oxygen currents that can be sustained by VRLA batteries with a design life of 20 years in float service. These currents were to be determined and used as the base-line.

(ii) Since there were seventeen elements to be examined, a screening plan, which could provide maximum outcome with reasonable effort, had to be developed.

(iii) An experimental procedure had to be devised to measure the float, hydrogen and oxygen currents from cells prepared from control oxide and oxides doped with residual elements in combination.

(iv) A data-analysis procedure had to be established to determine the levels of individual elements at which the measured float, hydrogen and oxygen currents were equal to the corresponding critical values. For each element, there would be three concentrations, namely, one for float current, one for hydrogen current and one for oxygen current. The lowest value would be taken as MAL for that element.

Lead produced by the Doe Run Company was chosen for preparation of the control oxide to which the residual elements were added. This is because Doe Run lead is of high purity and is used by many battery manufacturers in the USA. The oxide was made with Barton-pot method.

### EXAMPLES

The following sections detail the work program from which the new lead compositions, battery plates and batteries of the present invention were established, and actual lead compositions, pastes and battery plates made with the lead compositions of the preferred embodiments of the invention.

In the Examples, reference will be made to the following figures:

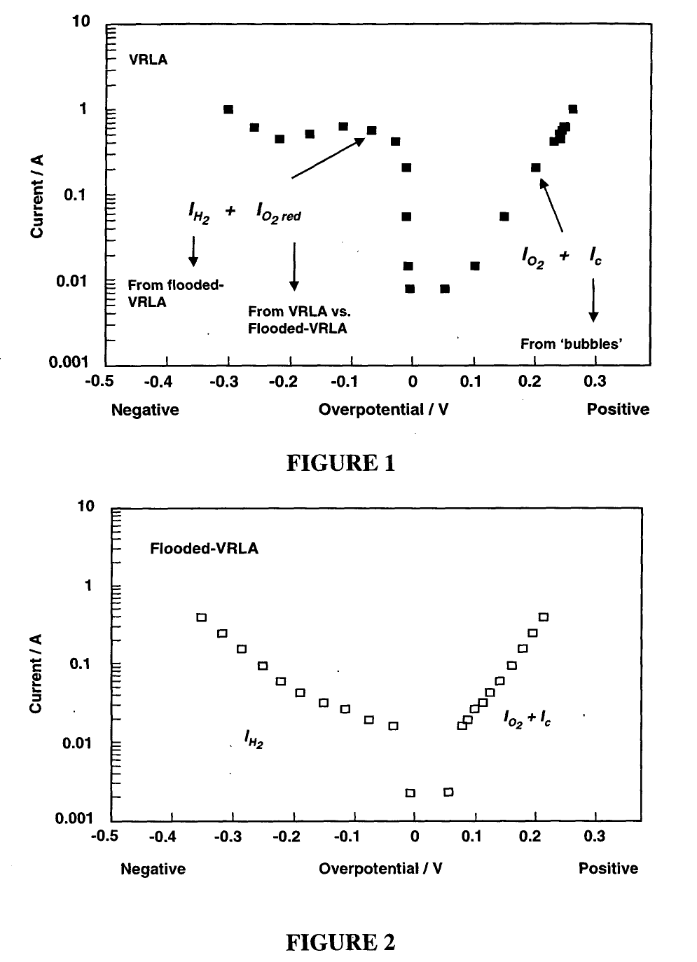

FIG. 1. Electrochemical characteristics of VRLA batteries.

FIG. 2. Determination of hydrogen-evolution current.

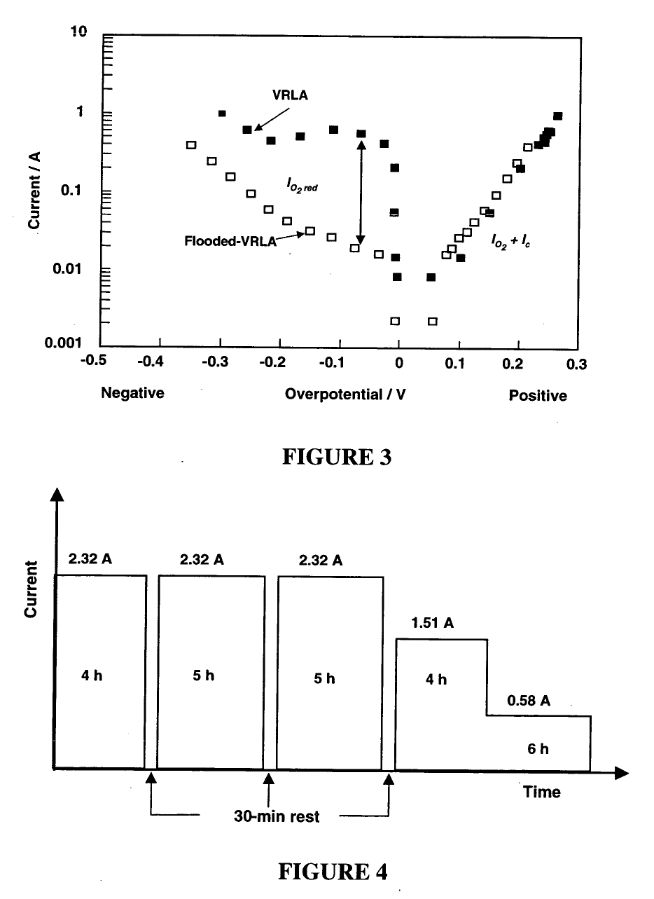

FIG. 3 Determination of oxygen-reduction current.

FIG. 4. Formation profile for battery plates.

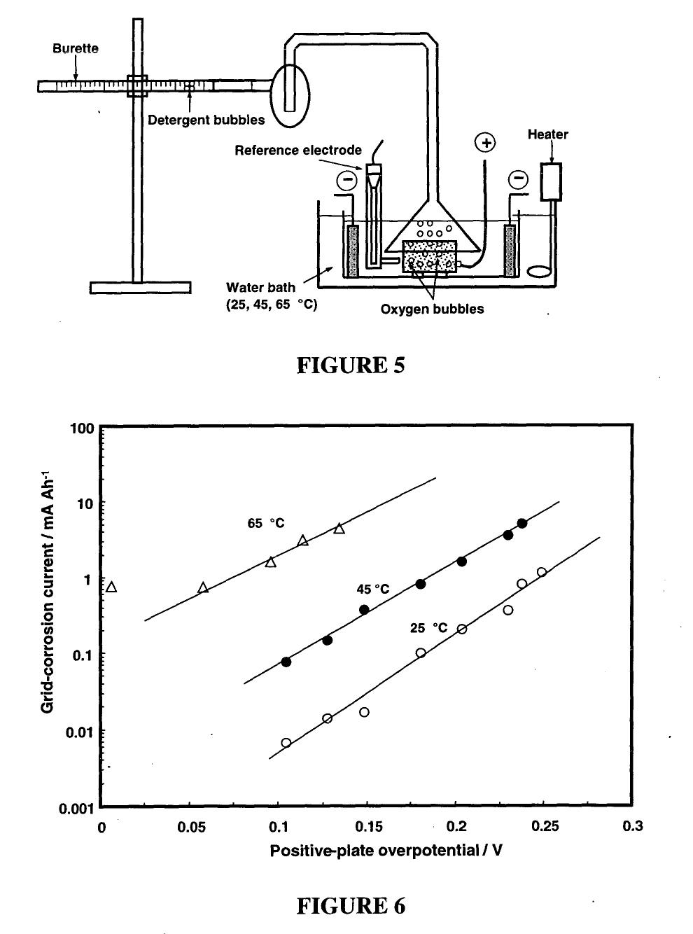

FIG. 5. Apparatus used to determine grid-corrosion and oxygen-evolution currents.

FIG. 6. Corrosion current of pasted Pb-0.09 wt. % Ca-0.8 wt. % Sn grid at different over-potentials and temperatures.

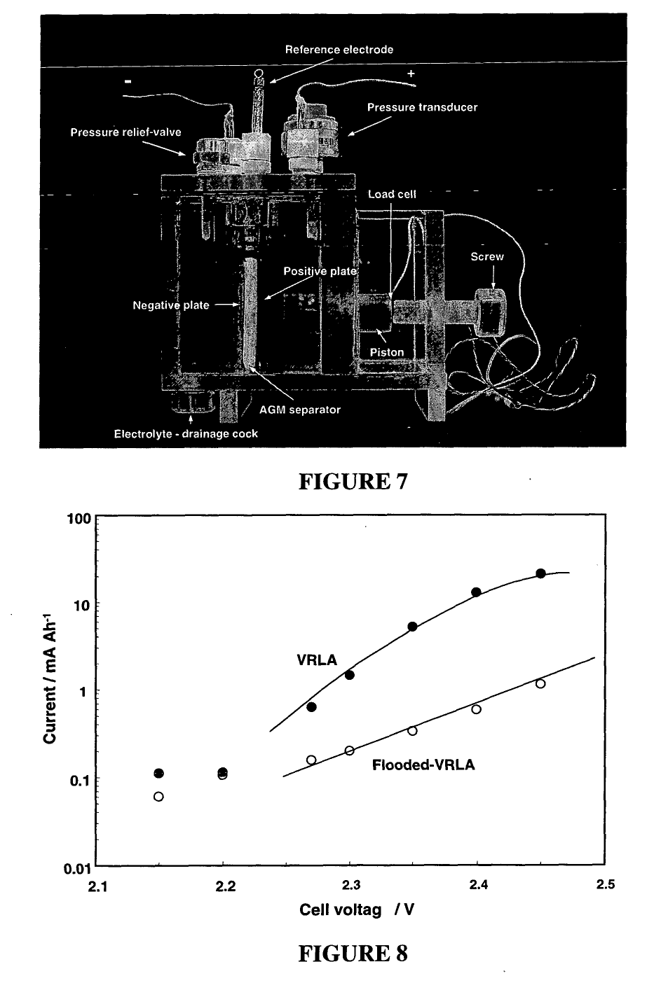

FIG. 7. Electrochemical cell used to determine hydrogen- and oxygen-evolution currents.

FIG. 8. Relationship between current and voltage for (O) flooded-VRLA and (●) VRLA cells at 21° C.

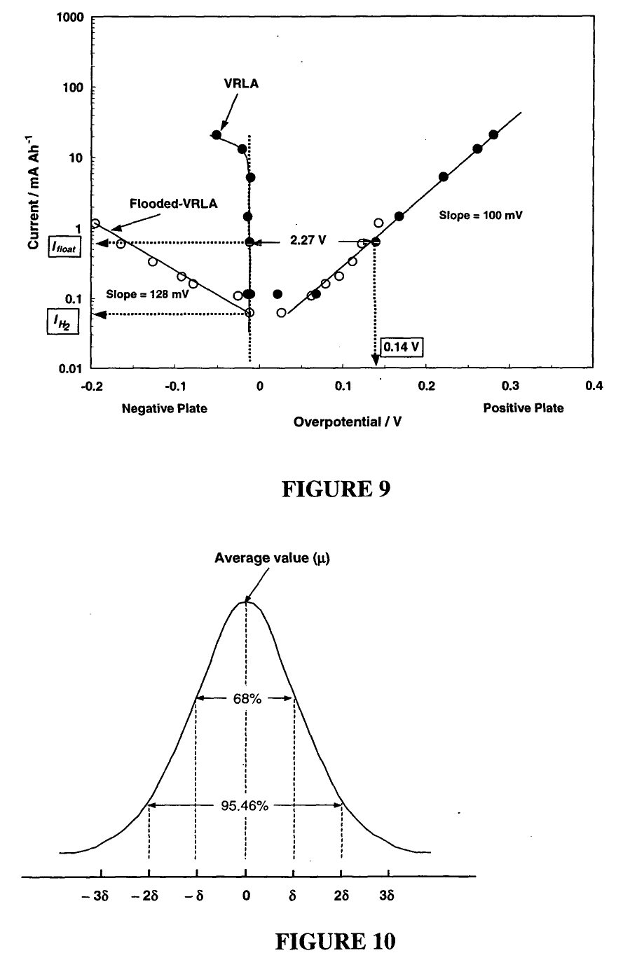

FIG. 9 Relationship between current and negative-plate/positive plate overpotential in ()) flooded-VRLA and (●) VRLA cells at 21° C.

FIG. 10. Normal law of error.

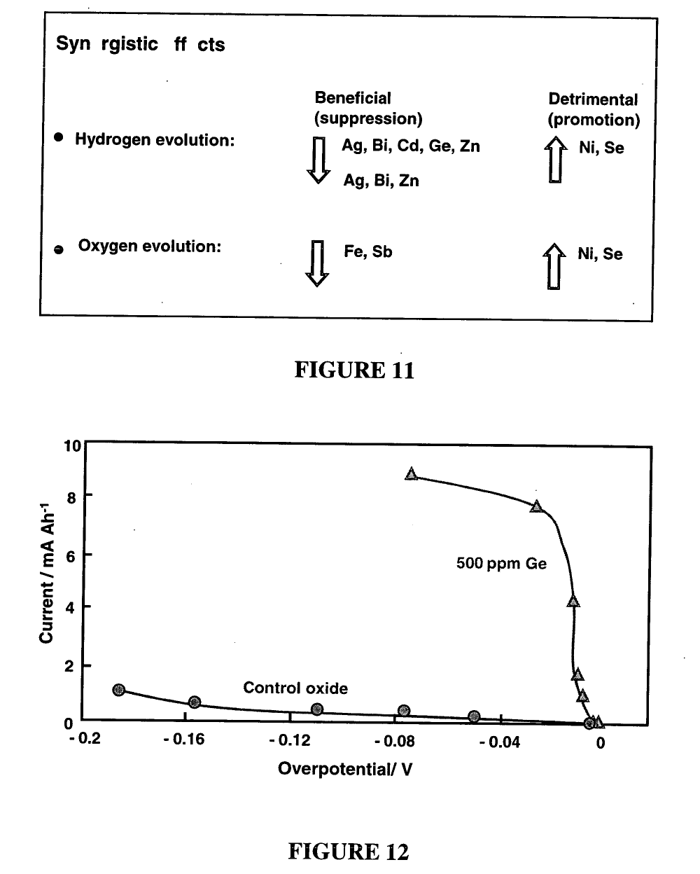

FIG. 11. Synergistic effects between elements.

FIG. 12. Hydrogen-evolution currents of control oxide and oxide doped with germanium.

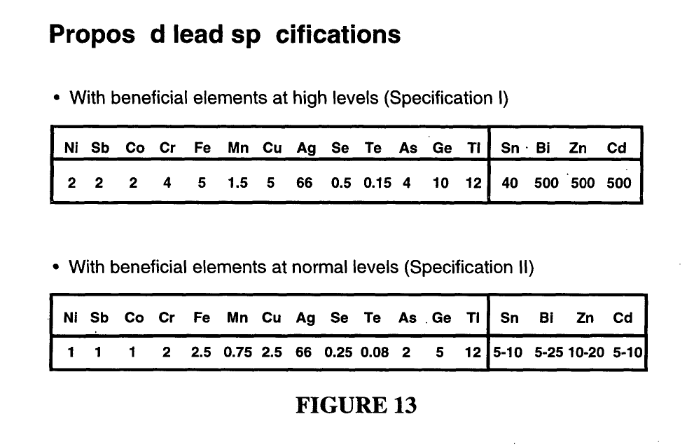

FIG. 13. Proposal specifications for lead used to produce VRLA batteries.

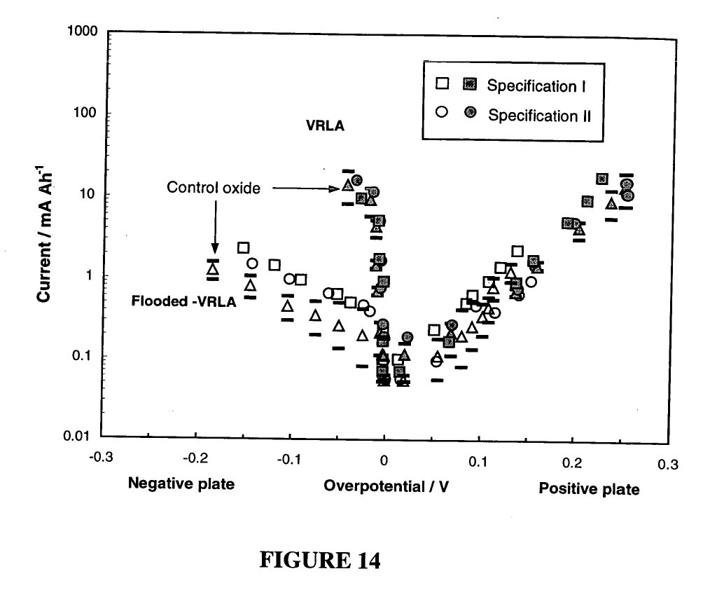

FIG. 14. Relationship between current and negative-plate/positive-plate overpotential at 21° C. for cells prepared from control oxide and from oxides with specification I or specification II.

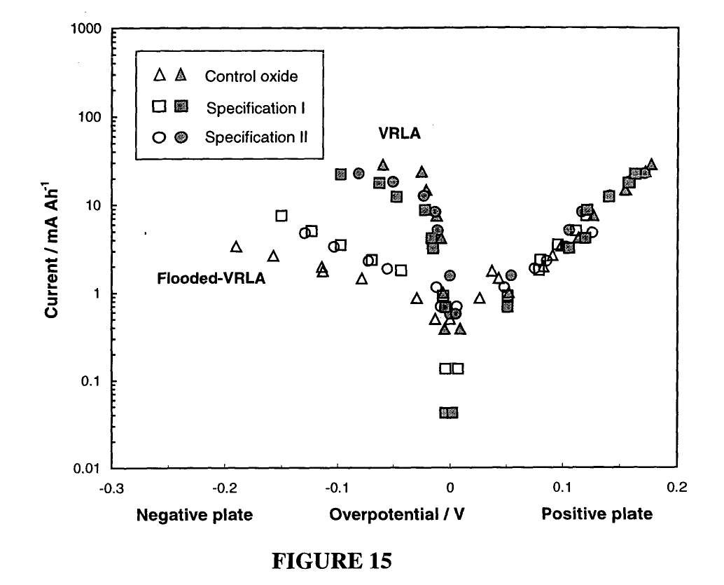

FIG. 15. Relationship between current and negative-plate/positive-plate overpotential in cells prepared from control oxide and from oxides with specification I or specification II at 45° C.

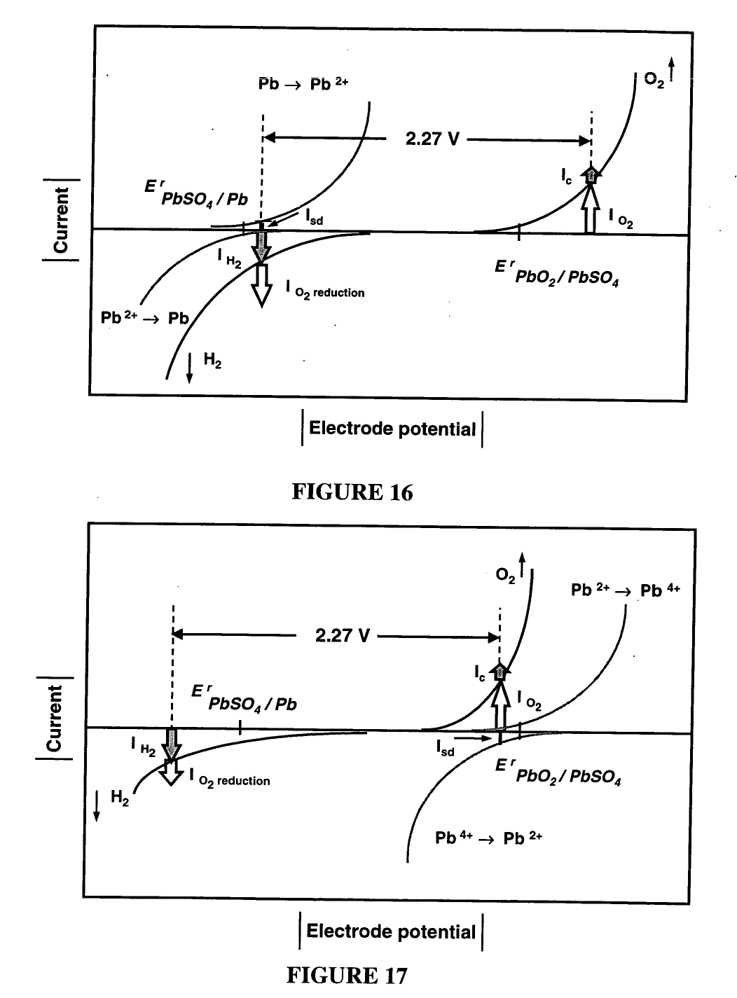

FIG. 16. Selective discharge of negative plate in VRLA cell during constant-voltage charging.

FIG. 17. Selective discharge of positive plate in VRLA cell during constant-voltage charging.

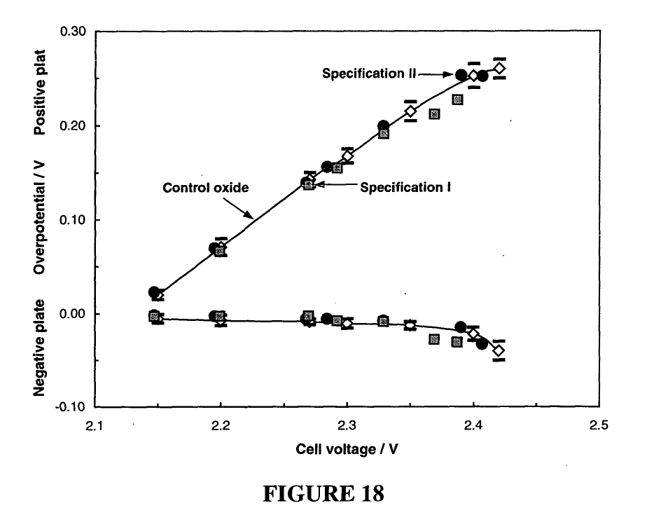

FIG. 18 Change in negative-plate and positive-plate overpotentials during overcharge at 21° C.

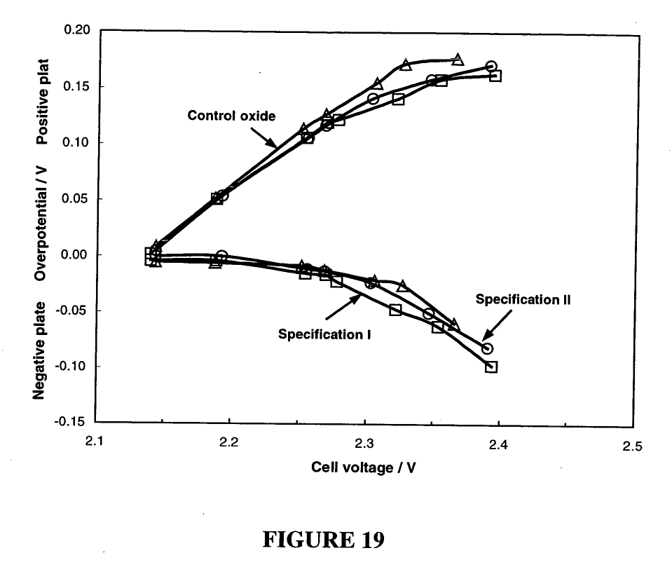

FIG. 19 Change in negative-plate and positive-plate overpotentials during overcharge at 45° C.

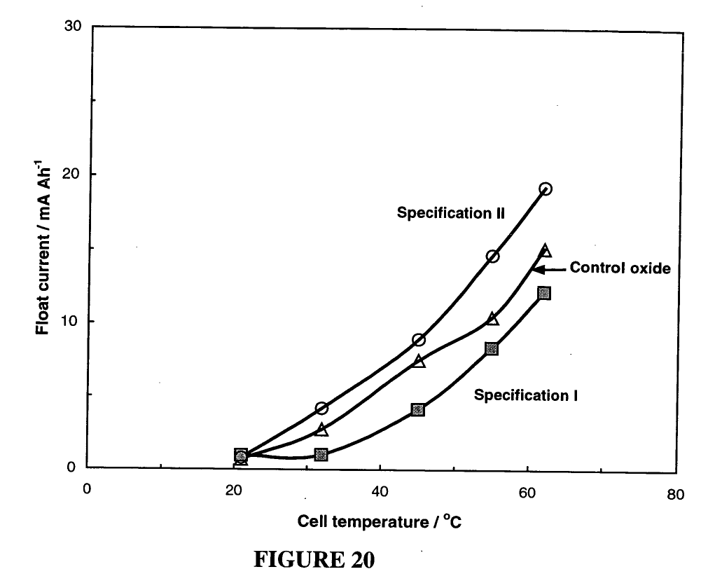

FIG. 20. Effect of temperature on float current of VRLA cells made from different oxides.

1. Critical Float, Hydrogen- and Oxygen-Evolution Currents

Brecht [1] has found that conventional, non-antimonial, flooded batteries used in stand-by applications can typically experience between 40 and 65% corrosion of the positive grid by the end of life. In addition, Brecht has calculated that for a VRLA battery, conversion of 50% of the grid metal to PbO₂ will produce a corresponding 20% reduction in the level of acid saturation, i.e., from 95 to 75%. This usually results in a 40%, or greater, loss of usable capacity. Thus, with the same degree of grid corrosion, the VRLA battery will fail because of electrolyte dry-out, and not because of grid corrosion. The assumption was made that VRLA batteries reach the end of life (i.e., 20 years) when at least half of the original grid metal is converted to PbO₂ through the following reaction.

Pb+2H₂O→PbO₂+4H⁺+4e⁻ (1)

Accordingly, the amount of water required to corrode 50% of the positive-grid material in a VRLA battery with, for example, a C₃ capacity of 100 Ah (total positive grid weight=1572 g/cell; amount of H₂SO₄, 1.285 rel.dens.=1414.7 g/cell; amount of H₂O=877.1 g/cell) is calculated to be 0.068 g/Ah/cell/year. This is equivalent to a hydrogen-evolution current of 0.023 mA/Ah/cell. During float charging of batteries, the corrosion current is generally 2 to 2.6% of the float current [2,3]. Using the average value of 2.3%, the float and oxygen-evolution currents delivered by the above VRLA battery will be 1.0 and 0.977 mA/Ah/cell, respectively.

In summary, the above analysis showed that to achieve a life of 20 years from a conventional VRLA with ˜100% recombination efficiency, the critical hydrogen/oxygen-evolution currents and float current are:

I_{float critical}=1.0 mA/Ah/cell (2)

I_{H}_{₂} _{critical}=0.023 mA/Ah/cell (3)

I_{O}_{₂} _{critical}=0.977 mA/Ah/cell (4)

These critical currents were used as the base-line for the determination of the MALs of both harmful and beneficial elements when added to the control oxide. Since the oxygen-recombination efficiency is close to 100%, it should be noted that the critical hydrogen-evolution current is equal to the current due to grid corrosion. The value given in this specification is expressed as mA per Ah at the 3-h rate.

2. Screening Plan—Plackett-Burman Experimental Design

Of all the various options for conducting the trials on the appropriate levels for elements in the lead composition, the Plackett-Burman design was chosen. This design was chosen because it has been widely and successfully used by industries to screen large numbers of variables with a reasonable number of trials. With a conventional factorial design, 2^{N} runs will be required to screen N variables. Thus, evaluation of 16 elements will require 65 536 runs—an impossible task. By contrast, the Plackett-Burman design can be used to determine separately either the maximum levels or the minimum levels of elements of interest. Furthermore, the advantage of this design is that the determination of either maximum or minimum levels of N elements requires only N+1 runs where N+1 is a multiple of 4. Accordingly, 17 experiments would be required to screen the effects of 16 elements on the hydrogen- and oxygen-gassing rates. Obviously, this number of experiments is not a multiple of 4. Therefore, a 19/20 plan was decided to be used. In fact, 27 runs were conducted to include repeat trials as well as some drift-check trials to determine the tolerance of the experimentation. For the Plackett-Burman design, starting “estimated MALs” had to be selected to commence the full experimental run.

It was postulated that the effect of residual elements on the rate of hydrogen evolution at the negative plate in a lead-acid system would decrease in the order:

Ni>Sb>Co>Cr>Fe>Mn>Cu>Se>Te>As>Sn>Ag>Bi>Ge>Zn>Cd

Clearly, for each element, there is a MAL of its concentration beyond which the element will cause unacceptable rates of hydrogen and/or oxygen. The aim, then, was to determine the MALs for the initially selected, 16 residual elements (Tl was added into this matrix in the later stage of the work program). Obviously, the Lower Levels are the actual levels of residual elements that are present in the Doe Run oxide. None of the MALs are known and, therefore, it was necessary to start the experimentation using our own estimated approximations. For some elements that we wished to test at higher levels, we deliberately increased the first approximations for their MALs to 500 ppm.

The initial Upper Level—Upper Level (1), the first approximation of the MALs—of each of the 16 elements is given in Table 2.

The complete Plackett-Burman design for 16 elements at two concentrations that was developed by the applicant is given in Table 3.

The combined levels of the 16 elements define an experimental run. Trial #1 is to check the control oxide. Trials #2 and #3 determine the gassing behaviour of oxide when doped with all the sixteen residual elements at high and mid levels. Trials #13 and #25 are repeats of trial #1. Trials #14 and #26 are repeats of trial #2. Finally, trial #27 is repeat of trial #6.

The Plackett-Burman design can only provide the main effect (i.e., single variable effect) of each of the 16 elements considered. It cannot provide ‘synergistic’ effects caused by two or more elements. (Note, ‘synergy’ is commonly used to describe an advantageous outcome, but in our case the result could be disadvantageous. Therefore, we use the terms ‘beneficial synergy’ and ‘detrimental synergy’ to distinguish between these two opposite situations.) From inspection of individual trials, we identified possible beneficial or detrimental synergistic effects between elements, and we subsequently conducted further work to determine quantitatively the levels of elements required to obtain beneficial synergies, and avoid detrimental synergies.

3. Determination of Electrochemical Characteristics

Oxygen evolution and grid corrosion occurs simultaneously at the positive plates during the overcharge of both flooded and VRLA cells. Hydrogen evolution is the predominant reaction at the negative plates in flooded cells, but is accompanied by oxygen reduction in VRLA designs (FIG. 1). Therefore, in order to determine the separate rates of these two reactions at the negative plate in a given VRLA cell, the oxygen-reduction process has to be suppressed in a parallel experiment performed with the same cell. This can be achieved by minimising the transport of oxygen from the positive plate through: (i) assembling the cell with no compression; (ii) inserting polyethylene separators with ribs facing the positive plates; (iii) flooding the cell with acid. To distinguish a cell prepared under such conditions from a conventional flooded type, the cell is referred to as a ‘flooded-VRLA’ design. The current-overpotential behaviour of a flooded-VRLA cell is given in FIG. 2. The current at the negative plate is now consumed only by hydrogen evolution. The difference in the negative-plate current between the VRLA and the flooded-VRLA cell at the same overpotential is the oxygen-reduction current (FIG. 3). For positive plates, the current in both cell designs (VRLA or flooded-VRLA) is the combined current of oxygen evolution and grid corrosion. Thus, to obtain the oxygen-evolution current, the corrosion current has to be determined separately (by ‘bubble’ experiments, see Section 3.2 below).

3.1. Construction of Electrodes

Negative- and positive-pasted plates were made from Doe Run oxide, as well as from this oxide doped with a combination of elements at the levels given in Table 3. Note, the concentrations of elements in the Doe Run oxide that are less than 1 ppm (see Table 2) were ignored when adding these elements to the required levels given in Table 3. Note, it is safer by doing this because the ‘true’ acceptable levels of the residual elements would be slightly higher than those specified by the study. The Doe Run oxide was supplied by Hammond Group, Inc. The paste formulae for the negative and the positive electrodes are presented in Table 4. For pastes prepared from control oxide doped with different levels of residual elements, the mixture of dried powder was placed in a plastic container. The container was then shaken for about 30 min before paste mixing. To exclude any contamination from the sulfuric acid required for paste mixing and battery electrolyte, analytical grade reagent was used throughout the project. After paste mixing, the paste was applied to positive and negative grids which had the dimensions and alloy compositions given in Table 5. The pasted plates were cured at 50° C./100% r.h. for 24 h, and then dried at 60° C./ambient humidity for 8 h. After processing, two positive and two negative plates, together with separator sheets, were assembled into 2-V cells. Dilute sulfuric acid (1.07 rel.dens.) was introduced and the cell was allowed to stand for at least 30 min. The formation was conducted using the profile shown in FIG. 4. Three rest periods of 30 min were included to facilitate the diffusion of acid into the interior of the plates. After formation, the electrolyte was adjusted to ˜1.285 rel.dens. with concentrated sulfuric acid (1.83 rel.dens.). The cell was ‘conditioned’ by applying 5 to 15 repetitive cycles with discharge at the 3-h rate. After full charging, the plates were used to determine the grid corrosion, hydrogen-evolution and oxygen-evolution currents.

3.2. Determination of Grid Corrosion

In general, grid corrosion is determined by means of a weight-loss procedure; the amount of corrosion is taken to be the difference in the weight of the grid before the corrosion test and after the corrosion layer has been dissolved. The accuracy of this procedure is dependent upon structural homogeneity of the grid alloy. A homogeneous structure, such as a high-antimony lead alloy, will favour uniform corrosive attack throughout the entire metal surface (i.e., general corrosion). In this case, there is high possibility for the complete digestion of corrosion layer. By contrast, a heterogeneous structure, such as found with low-antimony or lead-calcium-tin alloys, will suffer preferential attack at the grain boundaries of the metal surface; this results in penetration corrosion. Under such conditions, there will be incomplete dissolution of the corrosion layer and this will lead to a high uncertainty in results obtained via the weight-loss procedure. Since this study employs grids made from lead-calcium-tin alloys, an alternative ‘bubble’ method was employed to determine the rate of grid corrosion (FIG. 5).

An electrochemical cell was constructed and comprised one, fully-charged positive and two, fully-charged negative plates in acid of 1.285 rel.dens. The potential of the positive plate was measured with a 5M Hg|Hg₂SO₄ reference electrode. An inverted funnel was placed above the positive plate and was connected to a burette which was mounted horizontally. Prior to measurement, bubbles of detergent were introduced into the burette and a constant current was applied to the cell. The oxygen evolved from the positive plate was collected continuously by the inverted funnel and promoted the movement of the bubbles in the burette under the action of the increasing oxygen partial pressure. The rate of oxygen evolution is represented by the movement of detergent bubbles per unit time (i.e., volume change per unit time). The oxygen-evolution current was calculated using the following relationship.

I_{O}_{₂}=[4FV(Pₜₒₜₐₗ−P_{w})]/10⁶RTt (5)

where:

F=96 500 C mol⁻¹

V=gas volume (ml) collected in burette

Pₜₒₜₐₗ=101 325 Pa

P_{w}=vapour pressure (Pa) at temperature T

R=gas constant=8.31 J mol⁻¹ K⁻¹

T=absolute temperature (K)

t=duration of experiment (s)

Since the current at the positive plate is the combined value of oxygen evolution and grid corrosion, the latter current can be determined by:

I_{c}=I_{applied}−I_{O}_{₂} (6)

The above experiment was repeated at various applied currents and different temperatures (i.e., 25, 45 and 65° C.).

The corrosion current of a positive plate using a Pb-0.09 wt. % Ca-0.8 wt. % Sn grid at different potentials and temperatures is given in FIG. 6. There is a linear relationship between the corrosion current (logarithmic scale) and the positive-plate overpotential. This behaviour holds for all temperatures studied, i.e., 25, 45 and 65° C. The Tafel slopes increase with increase in temperature, namely, 63, 74 and 91 mV at 25, 45 and 65° C., respectively. This behaviour indicates a change in the mechanism of grid corrosion.

3.3. Determination of Hydrogen- and Oxygen-Evolution Currents

The cell used to determine the hydrogen- and oxygen-evolution currents is shown in FIG. 7. The main apparatus was constructed from polypropylene. The cell consists of a pasted-positive plate, a separator (AGM or combination of AGM and Daramic polyethylene), and a pasted-negative plate. A piston is arranged to move freely and is used to compress the plate group by turning a screw clockwise. The value of the plate-group pressure is measured by a load cell and can be adjusted by the screw. A plate-group pressure of 40 kPa was adopted.

3.3.1. Flooded-VRLA Cells

The positive and negative plates of the type discussed in Section 3.1, together with a polyethylene separator, were assembled with no compression into a 2-V cell, as shown in FIG. 7. The cells was then fitted with a 5 M Hg|Hg₂SO₄ reference electrode and was allowed to stand for at least 24 h for determination of the open-circuit voltage along with the negative-plate and positive-plate potentials. A voltage-step procedure was then used to determine the electrochemical characteristics of the cell. The method involved stepping the voltage of the cell to consecutive set values (i.e., 2.15, 2.20, 2.27, 2.30 . . . 2.45 V); the cell was held at each voltage for either 10 h (for voltages less than 2.30 V) or 5 h (for voltages greater than 2.27 V). During this time, the positive- and negative-plate potentials, the internal pressure, and the delivered current were recorded continuously. The values obtained after 10 or 5 h were used to plot either the current-voltage curve for the cell or the current-overpotential curve (Tafel plot) for each plate polarity.

3.3.2. VRLA Cells

Following the above voltage-step experiments, the polyethylene separator was removed and replaced with an absorptive glass-microfibre counterpart. The cell-group pressure was set at 40 kPa. Excess acid (not retained by the plates and separators) was decanted from the batteries. At this stage, the level of acid saturation in the separator was considered to be 100%. To achieve the desired saturation of 95%, the plate-group pressure was further increased to 42 kPa so that the excess acid was squeezed from the separator. The plate-group pressure was then released back to 40 kPa. Current-voltage and current-overpotential curves were obtained by means of the same voltage-step procedure as that described above for flooded-VRLA batteries.

4. Results and Discussion

4.1. First Plackett-Burman Design

4.1.1. Float, Hydrogen and Oxygen Currents of Control Oxide

Current-voltage plots at 21° C. (room temperature) for flooded-VRLA and VRLA cells prepared from control oxide are shown in FIG. 8. For the flooded-VRLA design, the cell exhibits a linear relationship between the current (logarithmic scale) and the cell voltage when the latter is in the range 2.27 to 2.45 V. By contrast, the VRLA assembly displays non-linear behaviour over the same voltage range; the current increases initially with increase in voltage but starts to level off at 2.41 V. At all cell voltages, the current delivered by the VRLA cell is significantly higher than that delivered by its flooded equivalent.

In order to understand the cause(s) of the above difference in current-voltage behaviour, Tafel plots were obtained for the two plate polarities, see FIG. 9. The positive plates in both cell designs have similar Tafel characteristics with a slope of ˜100 mV, i.e., a value which lies between those for oxygen evolution on α-PbO₂ and β-PbO₂ electrodes, viz., 70 and 140 mV, respectively [4]. The characteristics of negative plates in the flooded-VRLA cell differ markedly from those in the VRLA counterpart. The flooded-VRLA cell gives a Tafel plot with a slope of ˜128 mV. Note, this value is slightly higher than the theoretical value for hydrogen evolution (i.e., 120 mV), a discrepancy which has been observed by other authors [5]. The relationship between the total current and the negative-plate overpotential in the VRLA cell is not linear and is due to the influence of the competing reaction of oxygen reduction. This accounts for the difference in current-voltage behaviour of the two types of cell. The overpotential of negative plates in the VRLA cell is small (i.e., 0.004 to 0.010 V) compared with that in the flooded-VRLA counterpart when both cells are charged at a low cell voltage (i.e., 2.21 to 2.36 V). At the same overpotential, the total current consumed by the negative plates is significantly higher in the VRLA cell. Obviously, the additional current in the VRLA cell under constant-voltage charging at 2.27 V is 0.63 mA Ah⁻¹.

The float current at the positive plate is equal to the combined currents of oxygen evolution and grid corrosion, i.e.,

I_{float}=I_{O}_{₂}+I_{c} (7)

The value of I_{c} at the overpotential of the positive plate (i.e., 0.14 V, FIG. 9) of the VRLA cell when float charging at 2.27 V can be determined from FIG. 7 and is 0.022 mA Ah⁻¹. Accordingly, from eqn. (7), the oxygen-evolution current is 0.63−0.022=0.608 mA Ah⁻¹.

The float current at the negative plate of the VRLA cell when charging at 2.27 V is the combination of the hydrogen-evolution and oxygen-reduction currents, i.e.,

I_{float}=I_{H}_{₂}+I_{O}_{₂} _{reduction} (8)

To obtain the hydrogen-evolution current, a straight line is drawn perpendicularly at the negative-plate overpotential of the VRLA cell to the x-axis in FIG. 10. The y-axis of the intersection between the perpendicular line and the performance curve of the flooded-VRLA cell gives the hydrogen-evolution current. The value is 0.058 mA Ah¹. Consequently, from eqn. (7), the oxygen-reduction current is found to be 0.572 mA Ah⁻¹. This gives an oxygen-recombination efficiency of 94.1% (i.e., the ratio of oxygen-reduction current to oxygen-evolution current).

From eqns. (7) and (8), the hydrogen-evolution current at the negative plate is seen to be equal to the combined currents of grid corrosion at the positive plate and any evolved oxygen which is not subsequently reduced at the negative plate (uncombined-oxygen current), i.e.,

I_{H}_{₂}=I_{c}+(I_{O}_{₂}−I_{O}_{₂} _{reduction}) (9)

Thus, the uncombined-oxygen current (I_{O}_{₂}−I_{O}_{₂} _{reduction}) is: 0.058−0.022=0.036 mA Ah⁻¹.

As mentioned in Section 1, the critical hydrogen-evolution current is determined at 100% oxygen-recombination efficiency. In other words, this current is calculated from the consumption of water due to grid corrosion, see eqn. (1). Since the oxygen-recombination efficiency of the VRLA cell examined here is 94.1%, the portion of the hydrogen-evolution current which is associated with grid corrosion is determined by subtracting the current due to uncombined-oxygen evolution from the total hydrogen current given in eqn. (9), i.e., 0.058−0.036=0.022 mA Ah⁻¹.

4.1.2. Float, Hydrogen and Oxygen Currents of Oxides Doped with Sixteen Elements

A similar procedure was used to determine the float current, the hydrogen-evolution current (associated with grid corrosion) and the oxygen-evolution current of cells using oxide doped with sixteen residual elements at combined levels given by Plackett-Burman design using the first Upper Levels (Upper Levels (1), Table 2). The results (Table 6) show that all three currents are lower than their corresponding critical values in the undoped cell (trials #1, #13, #25) and the 12 doped cells (trials #4, #6, #7, #9-#11, #16, #18-#20, #22, #27). The remaining 12 doped cells give: (i) lower float and oxygen currents, but higher hydrogen (trials #3, #12, #21, #24); (ii) higher float and oxygen currents, but lower hydrogen current (trials #8, #15, #17); (iii) higher float and hydrogen currents, but lower oxygen current (trial #5); or (iv) higher float, oxygen and hydrogen currents (trials #2, #14, #23, #26). Although the doped cell in which all 16 elements were added at high levels (trial #2) delivers float, hydrogen and oxygen currents above the corresponding critical values, the differences are quite small. This indicates that the selected, Upper Levels (1) are reasonable.

4.1.3. Experimental Reliability

In order to check the reliability of the data, a statistical analysis of the measured float, hydrogen and oxygen currents obtained for each set of repeated trials (see, Table 6) has been performed. Statistical theory shows that the distribution of a set of n measurements under identical experimental conditions can be assumed to follow a rule that is known as the ‘normal law of error’. For each set, the individual measurements cluster more or less around the average value (FIG. 10), i.e., measurements that differ only a little from the average are more frequent than those that differ substantially from the average. The average value, m, is calculated by diving the sum of the individual values in a set by the number of measurements, i.e.,

$$m = {\sum }_{i = 1}^{i = n} {x}_{i} / n \qquad ( 10 )$$

where x is the measured value and n is the number of measurements. The value of m will be the ‘true average’, μ, of the set if a very large number of measurements is conducted (i.e., if n→∞).

The relationship between the frequency of occurrence of a measurement and the amount by which it differs from the population average is shown in FIG. 10. The abscissa is expressed in units that represent the progressive deviation from the average value, namely, multiples of the standard deviation. The standard deviation at the peak of the graph is zero. The standard deviation, 6, is computed by using the following equation:

δ={[(x₁−m)²+(x₂−m)²+(x₃−m)²+ . . . (xₙ−m)²]/(n−1)}^{1/2} (11)

where n−1 is the number of degrees of freedom in the set of measurements. The term [(x₁−m)²+(x₂−m)²+(x₃−m)²+·(xₙ−m)²]/(n−1) is the variance. Thus, the standard deviation is the square root of the variance.

As mentioned above, ‘true values’ of the average and the standard deviation are obtained only from a very large set of measurements. In practice, however, this is not achievable because of time and cost restrictions. Accordingly, a small set of measurements is usually performed. The average value of a small set, m, will be spread around the ‘true average’, μ, of a very large set. (Note, to avoid confusion, the symbols used for average and standard deviation of the small set of measurements are expressed as m and s.) Therefore, it is necessary to determine a procedure by which it is possible to make statements that will relate the average of a small set to the true average of the large set. This problem was solved in 1908 by the English Chemist W. S. Gosset who introduced the factor, t. Multiplication of this factor by the ratio between the standard deviation and the square root of the number of measurements gives the uncertainty, U, of the average value m, as calculated by using eqn. (5), i.e.,

U=t×s/(n)^{1/2} (12)

The average, variance and standard deviation of three sets of repeated measurements are given in Table 7. The first set is for trial #1 (control oxide) and its repeats. The second set is for trial #2 (oxide doped with all 16 elements at high levels) and its repeats. The third set is for trial #6 (oxide doped with 16 elements at various levels, see Table 3) and its repeat. Since the number of degrees of freedom of each set is small, the uncertainties of the average values of individual sets will be large. Therefore, the pooled uncertainty of the three sets has been determined at the 95% confidence limit. At this limit, the uncertainties of the average values (based on 6 observations) of the float, hydrogen and oxygen currents are ±6.500×10⁻², ±1.930×10⁻³ and ±6.465×10⁻², correspondingly. These values will be used later to check the reliability of oxide containing 16 elements at MALs. For example, after determination of the MALs of the 16 elements, the float, hydrogen and oxygen currents of positive and negative plates prepared from the oxide with this new specification will be measured. The respective values of the three currents should be equal or less than 0.935 mA Ah⁻¹ (i.e., critical value−uncertainty=1−0.06500), 0.021 mA Ah⁻¹ (i.e., 0.023−0.00193) and 0.912 mA Ah⁻¹ (i.e., 0.977−0.06465). If these conditions are met, it can be assured with 95% confidence that the oxide with advanced specification will deliver safe float, hydrogen and oxygen currents.

4.1.4. Determination of Rates of Change of Individual Elements

In order to obtain the concentration of each element at which the measured float, hydrogen and oxygen currents are equal to their corresponding critical values, it is necessary to determine the rates of change per unit concentration (ppm) of float, hydrogen and oxygen currents for each element. Table 8 is used to determine the rates of change of individual elements and this table is the consequence of the Table 6 in which trials #2 and #3 (16 elements at high and mid levels) and trials #13, #14, #25-#27 (repeat trials) are removed. There are 10 trials for each element when its concentration is at a high level and 10 trials at a low level. For example, the concentration of copper at high level 10 ppm) is defined by trials #4, #5, #7, #9, #16, #17, #20, #23, #24, while that at low level (0 ppm) is defined by trials #1, #6, #8, #10-#12, #15, #18, #21, #22. On averaging the trials for copper at high level (10 ppm), the float (0.8579 mA Ah⁻¹), hydrogen (0.0218 mA Ah⁻¹) and oxygen currents (0.8361 mA Ah⁻¹) are obtained (Table 9). The remaining elements will be at mid levels. Similarly, on averaging the trials for copper at low level (0 ppm), the float (0.7954 mA Ah⁻¹), hydrogen (0.0180 mA Ah⁻¹) and oxygen (0.7778 mA Ah⁻¹) currents are obtained. When the copper concentration is raised from 0 to 10 ppm, the difference in float current is 0.0625 mA Ah⁻¹. Thus, the rate of change will be 0.00625 mA Ah⁻¹ per ppm if it is assumed that there is a linear relationship between float current and copper concentration. The rates of change in hydrogen and oxygen currents are equal to 0.00038 mA Ah⁻¹ per ppm and 0.00583 mA Ah⁻¹ per ppm, respectively. Using a similar procedure, the rate of change in the float, hydrogen and oxygen currents for each of the remaining elements are calculated; the results are given in Table 9.

With these rates, the levels of copper, at which the measured float, hydrogen and oxygen currents are equal to their corresponding critical values, are adjusted through the following example.

The float, hydrogen and oxygen currents of copper, when its concentration is at high level (10 ppm), are 0.8579, 0.0218 and 0.8361 mA Ah⁻¹, respectively (Table 9). In order to increase these currents to the corresponding critical values, namely, 1.0000 (float), 0.0230 (hydrogen) and 0.9770 mA Ah⁻¹ (oxygen), the copper concentration should be increased from 10 ppm to:

(i) Float Current

10 ppm +(1−0.8579) mA Ah⁻¹/0.00625 mA Ah⁻¹ ppm⁻¹=32.736 ppm

(ii) Hydrogen Current

10 ppm +(0.0230−0.0218) mA Ah⁻¹/0.00038 mA Ah⁻¹ ppm⁻¹=13.158 ppm

(iii) Oxygen Current

10 ppm +(0.9770−0.8361) mA Ah⁻¹/0.00583 mA Ah⁻¹ ppm⁻¹=34.168 ppm

Although there are three levels obtained for copper, the lowest level (i.e., ˜13 ppm) is taken as MAL. This is because if either of the other two levels is chosen, the hydrogen current will be above its critical value. Similar calculations were used to determine the levels of the remaining elements. Nevertheless, it is found that there are some elements (i.e., Ni, Sb, Co, Cr, Fe, Ag, As, Bi, Ge, Zn, see Table 9) for which the levels cannot be determined because of the negative value of the rates of change, especially for hydrogen current. The negative rate of change of hydrogen current indicates that the hydrogen-evolution current decreases when the levels of these elements are increased. This is particularly not true for Ni, Sb and Co as these elements are well known to promote hydrogen gassing. Furthermore, the above finding is contrary to the observations made in our previous studies [6] and by other authors [7-10] when the three elements are added singularly, but not in combination with other elements as performed in the present work. This indicates that certain elements in the sixteen matrix have masked (or suppressed) the effects of Ni, Sb and Co on hydrogen gassing. Thus, it was considered important to identify the element, and/or group of elements, that can suppress the rates of hydrogen and oxygen evolution.

4.2. Determination of Synergistic Effects Between Elements

In order to determine the masking effects of elements, it is necessary to separate the experimental trials shown in Table 8 into two groups. One group delivers hydrogen currents that are greater than the critical value. The other group delivers currents that are lower than the critical value. The grouping of the experimental trials is given in Table 10. In the absence of Zn (i.e., 0/5 frequency of presence), oxides containing Se (5/5), together with Ni, Ni and Co, or Sb and Co, always deliver hydrogen currents that are greater than the critical value (trials #5, #23, #24, #12, #21). This indicates that Zn has strong ability to suppress hydrogen gassing. Oxide containing Ni and Se gives the highest hydrogen current (i.e., 0.041 mA Ah⁻¹, trial #5), even when Cd is present at 500 ppm. This hydrogen current is much greater than the value given by oxide containing Se alone at a high level (0.0224 mA Ah⁻¹, Table 9) and that when the experiment is conducted on oxide containing Ni, Sb and Co all at 5 ppm (0.03 mA Ah⁻¹). This indicates that there is a detrimental synergy between nickel and selenium. Under these conditions, cadmium alone cannot suppress hydrogen gassing. The hydrogen current is, however, decreased from 0.041 to: (i) 0.028 mA Ah⁻¹ (trial #23) in the presence of Ag and Ge; (ii) 0.021 mA Ah⁻¹ (trial #17) in the presence of Bi, Ge, Zn and Cd; (iii) 0.020 mA Ah⁻¹ (trial #15) in the presence of Ag, Zn and Cd; (iv) 0.008 mA Ah⁻¹ (trial #22) in the presence of Ag, Bi and Zn. Furthermore, oxides containing Ni, Sb and Co also give low hydrogen currents only when Bi, Zn and Cd or Ag, Bi, Ge and Cd are present (trials #9 and #8). This suggests that Ag, Bi, Ge or Cd do mask the hydrogen-gassing effects of Ni, Sb, Co and Se. The masking ability, however, becomes prominent when Ag, Bi, Ge and Cd are added collectively without/with Zn. The group of elements that provide the best masking effect is the combination of Ag, Bi and Zn.

It was considered that beneficial/detrimental synergistic effects between Ag, Ni, Co and Se and any masking effects by the remaining twelve elements might be found if examined in greater detail. Consequently, the above grouping process was also performed for oxygen currents. The results are also presented in Table 11. In the absence of Sb (i.e, 1/5 frequency of presence) and/or Fe (i.e., 1/5 frequency of presence), oxides containing Ni (5/5 frequency of presence), together with Se (4/5) and Cd or Co, Ag, Se and Cd always deliver oxygen currents above the critical value. For these elements, the oxide containing mainly Ni, Se and Cd gives the highest oxygen current (i.e., trial #17). The magnitude of the oxygen current decreases, however, below its critical value (0.977 mA Ah⁻¹) when either Sb or Fe, or both elements are present. In particular, the oxygen current decreases significantly to 0.461 mA Ah⁻¹ (trial #22) even though the oxide contains elements, namely, Ni, Ag and Se, that are known to promote oxygen gassing. From these results, it can be concluded that Ni and Se also exert a detrimental synergistic effect on oxygen gassing. The effect is not, however, as strong as that for hydrogen evolution. Either Sb or Fe alone can mask the oxygen-gassing effects of Ni, Co, Ag and Se, but the strongest masking action is found with a combination of these two elements.

A summary of the synergistic effects of the various residual elements in lead on hydrogen and oxygen evolution is presented in FIG. 11.

4.3. Second Plackett-Burman Design

The above results do show that most of the beneficial elements exert the masking ability on the hydrogen-gassing effects of the harmful elements such as Ni, Sb and Co. Thus, in order to determine the MALs of these elements, the beneficial elements such as Bi, Zn and Cd should be removed from the second Plackett-Burman design (Table 12). The float, hydrogen and oxygen currents of the control oxide and oxides doped with seven elements are measured and the results are given in Table 13. Furthermore, since the MALs of Bi and Zn still could not be obtained in combination, the individual MALs of these elements were determined singularly (adding only Bi or Zn to the control oxide). In addition to Bi and Zn, the MALs of As, Cd, Fe, Sn and Tl were also verified singularly. The results are given in Table 14. Using the similar procedure as shown in Section 6.1.4, the levels of seventeen elements at which the measured float, hydrogen and oxygen currents are equal to their corresponding critical values are calculated and the data are listed in Table 15. The individual MALs of these elements are determined according to the following considerations.

For each element, there are three levels at which the measured float, hydrogen and oxygen currents are equal to the corresponding critical values. Nevertheless, the lowest level is taken as the MAL. For example, Ni has three levels, namely, 4 ppm for float current, 16 ppm for hydrogen current, and 4 ppm for oxygen current. Thus, the MAL of Ni is 4 ppm.

Fe is chosen at 10 ppm even though this level is expected to be much lower than its ‘true’ MAL. This is because it AGM separators are known to contain significant amounts of Fe. Thus, it is possible that the progressive leaching of this element from the separator during cycling could cause gassing problems if a high level is set for Fe in lead.

The level of Ge is 10 ppm, even though its MAL is 250 ppm. This is because the hydrogen current for oxide doped with Ge at 500 ppm shows abnormal behaviour (FIG. 14). The hydrogen current is low initially, but increases sharply as the negative-plate overpotential shifts slightly to a more negative value. Consequently, Ge is not considered to be a beneficial element.

The MALs of the beneficial elements Bi, Cd and Zn are estimated at 500 ppm, and that of Sn at 50 ppm, preferably 40 ppm. This is due to the uncertainty of the level for each of these elements at which the measured hydrogen current reaches the critical value.

4.4 Proposed Lead Specifications for VRLA Cells

From the MALs obtained for the individual 17 elements, two specifications for lead are proposed, namely, specifications I and II (FIG. 13). The levels of the individual elements are based upon the following considerations.

Specification I

The levels of beneficial elements such as Bi, Cd and Zn are set at 500 ppm and that of Sn at 40 ppm (although, in reality, the level of tin, being beneficial, could be up to 50 ppm).

Most of detrimental elements are specified at the mid levels or slightly lower than the mid levels of their corresponding MALs. This is because the oxide used to produce both the positive and negative plates is made from the same lead. Furthermore, there is a high risk of element migration between the two plate polarities during battery service. In the case of Co, for example, the MAL is 4 ppm and thus the specified level is 2 ppm. This is because, if the level was set at 4 ppm, the total level of Co at the negative plate could reach 8 ppm during service, due to migration from the positive plate, and this will exceed the MAL for the hydrogen current (i.e., 7 ppm). Under such a situation, the delivered hydrogen current will be greater than its critical value.

Ag is set at its MAL (i.e., 66 ppm) because the total level of this element at the negative plate, even after complete migration, will still be lower than the level for the hydrogen current, viz., 142 ppm.

Specification II

The levels of beneficial elements are reduced to the values normally found in refined lead which are well below 500 ppm.

Except for Ag, the levels of harmful elements in specification I are further decreased due to the negligible masking effects of the beneficial elements at their now reduced levels.

Ag is still kept at 66 ppm. This is because, at this level, Ag does not affect oxygen and hydrogen gassing even though the levels of the beneficial elements are reduced.

Two specifications for lead are proposed because some lead producers may not wish to add the beneficial elements at high levels. The next step is to examine the performance of positive and negative plates with active material produced from oxide using the proposed two specifications for lead.

4.5. Performance of Negative and Positive Plates Prepared from Lead of Specification I or II

4.5.1. Float Hydrogen and Oxygen Currents of Oxides with Proposed Specifications

Several VRLA cells were constructed using control oxide and oxides doped with 17 elements at the levels set in specifications I and II. The float, hydrogen and oxygen currents of these cells were determined at 21 and 45° C., respectively. The charging capability of the negative and positive plates of the above cells during float service, particularly at elevated temperatures, was also evaluated.

Current-voltage plots at 21° C. for flooded-VRLA and VRLA cells prepared from control oxide and oxides with either specification I or specification II are shown in FIG. 14. For the flooded-VRLA design, the cells using oxides with either specification I or II deliver higher current than that using control oxide. This is expected and understandable because the levels of residual elements in specifications I and II are set higher than those in the control oxide. There is little difference in the current response between cells using oxide with specification I and specification II, even though the levels of harmful elements in the former oxide are greater. This indicates that the high levels of beneficial elements, i.e., Bi, Cd, Sn and Zn, have masked the adverse gassing effects of the harmful elements. For the VRLA design, there is no major difference in the current-voltage behaviour of all cells, irrespective of the degree of oxide purity examined in this project. There are no marked changes in current-voltage behaviour when cells are operated at a higher temperature of 45° C., FIG. 15.

Using the data presented in FIGS. 14 and 15, the float, hydrogen and oxygen currents are determined for the control oxide and oxides doped with 17 elements at the levels set in either specification I or II. The data are given in Table 16. At 21° C., the cells prepared with doped oxides deliver higher float, hydrogen and oxygen currents than the cell using control oxide. Furthermore, the cell produced from oxide with specification I gives a similar hydrogen current, but higher float and oxygen currents, than the cell using oxide with specification II. All cells deliver the three currents within their corresponding critical values. At 45° C., the cell using oxide with specification I gives the lowest float, hydrogen and oxygen currents. On the other hand, the cell prepared from oxide with specification II shows an almost similar hydrogen current, but higher float and oxygen currents, than the control. Since there are no data available for the critical float, hydrogen and oxygen currents at 45° C., comparison with the measured values at this temperature cannot be made.

To date, results show clearly that cells using oxides of either specifications I or II deliver satisfactory float, hydrogen and oxygen currents which are within their corresponding critical values. This is true even when the uncertainty of the experiment is taken into account, i.e., ±6.500×10⁻², ±1.930×10⁻³, and ±6.465×10⁻² for the corresponding float, hydrogen and oxygen currents, Table 7. The next step was to examine the charging capability of the above cells.

4.5.2. Conditions for Selective Discharge

During float service, lead-acid cells are maintained in a charged state for most of their operational time. In this condition, hydrogen evolution, oxygen evolution and grid corrosion occurs in flooded-electrolyte cells, but are joined by oxygen reduction in VRLA counterparts. Although both designs operate differently, the requirements for float service are the same, namely, a low float current and minimal grid corrosion. These two criteria are imposed mainly to minimize water loss from the batteries. This is particularly important for VRLA cells which contain less acid than flooded-electrolyte counterparts. A further essential requirement, but often not realized, is that the negative and positive plates in lead-acid cells on float service should remain in a fully-charged state. Otherwise, the cells cannot provide full and stable capacity. In order to meet this condition, the potential of the negative plate should be at more negative values during charging, and that of the positive plate at more positive values, than the corresponding equilibrium potentials (E^{r}_{PbSO}_{₄}_{/Pb} and E^{r}_{PbO}_{₂}_{/PbSO}_{₄}, respectively). In other words, the overpotential of the negative plate, η=Eⁱ−E^{r}_{PbSO}_{₄}_{/Pb}, should be less than zero and that of the positive plate, η+=Eⁱ−E^{r}_{PbO}_{₂}_{/PbSO}_{₄}, should be greater than zero. It is known, however, that conditions can arise whereby the overpotential of the negative plate becomes greater than zero and the negative plate suffers ‘selective discharge’, or the overpotential of the positive plate becomes lower zero (i.e., ‘selective discharge’ of positive plate). It is therefore important to examine the changes in the overpotentials of negative and positive plates during overcharge in cells using control oxide and oxides with specifications I or II.

Selective Discharge of Negative Plate

During overcharging, the potentials of the positive and negative plates shift so that the same amount of current flows through both polarities. In a practical VRLA cell (i.e., low hydrogen-evolution rate), the current consumed by hydrogen evolution at the negative plate equals the sum of that consumed by grid corrosion and any uncombined oxygen at the positive plate. Furthermore, this condition is achieved at a negative-plate potential which is at more negative values than its equilibrium value. An unbalanced VRLA cell can result from excessive evolution of hydrogen through contamination of the negative material with impurities. This is shown schematically in FIG. 18; to assist the explanation, current-potential curves for the discharge and the charge reactions of the negative plate are also included. Such contamination may originate from the starting leady oxide and/or from the electrolyte. On subjecting the battery to constant-voltage charging, the potential of the negative plate will shift towards more positive values in order to balance the current flow through both polarities. If the current consumed by hydrogen evolution at the negative plate is still greater than that consumed by grid corrosion and any uncombined oxygen at the positive plate, the negative-plate potential will be driven to a value which is more positive than the equilibrium potential. In such a situation, the current will be balanced by selective discharge (I_{sd}, FIG. 16) of the negative plate via the following reaction couple:

2H⁺+2e⁻→H₂ (13)

Pb+H₂SO₄→PbSO₄+2H⁺+2e⁻ (14)

Obviously, the rate of hydrogen evolution in a VRLA cell exerts a strong influence on the selective discharge of the negative plate. Such discharge is further enhanced if the battery uses a highly corrosion-resistant grid alloy, and/or has a very high oxygen-recombination efficiency (e.g., as a result water loss during prolonged operation).

Selective Discharge of Positive Plate

When the rate of oxygen evolution at the positive plate is enhanced (e.g., through the influence of impurities) and the efficiency of oxygen reduction at the negative is low, i.e., <80%, the positive-plate potential will decrease towards the equilibrium value in order to provide the same flow of current through each plate polarity (FIG. 17). If the potential of the positive plate moves to a value more negative than the equilibrium potential and the combined current due to the oxygen evolution and grid corrosion is still higher than that consumed by oxygen reduction and hydrogen evolution at the negative plate, then the difference will be taken up by selective discharge of the positive plate via the following reaction couple:

2H₂O→O₂+4H⁺+2e⁻ (15)

PbO₂+2H⁺+H₂SO₄+2e⁻→PbSO₄+2H₂O (16)

The rate of selective discharge will be increased further if the positive plate uses a grid alloy which is more susceptible to corrosion.

Clearly, the negative plate or the positive plate in a VRLA cell can only become selectively discharged when the overpotential is equal/greater than zero or equal/less than zero, respectively, i.e., η₋≧0, η₊≦0. Thus, the possibility of selective discharge can be confirmed by measurement of the plate overpotentials during overcharging at various constant voltages.

4.5.3. Charging Capability of VRLA Cells Produced from Control Oxide and Oxides with Proposed Specifications

(i) Change in Overpotential of Negative and Positive Plates During Overcharge

When charging VRLA cells at 21° C. with voltages up to 2.30 V, the potential of negative plate remains close to its equilibrium value, i.e., −0.003 to −0.02 V (FIG. 18). Obviously, there is a corresponding marked increase in the overpotential of the positive plate. With further increase in the charging voltage (i.e., >2.30 V), the absolute values of the overpotential of both plate polarities increase, but that of the positive plate starts to level off at voltage greater than 2.4 V. The change in plate overpotentials is similar in all cells, irrespective of the oxide used, i.e., control oxide, oxide with specification I, or oxide with specification II.

The change in overpotentials of negative and positive plates in VRLA cells at 45° C. is presented in FIG. 19. For each cell, the negative-plate overpotential decreases slightly when the voltage is increased up to 2.25 V. Obviously, there is a corresponding marked increase in the overpotential of the positive plate. With further increase in charging voltage, however, the overpotential of the negative plate decreases at a greater rate than that of the positive plate. In addition, the overpotential of the positive plate starts to level off at cell voltage greater than 2.35 V. As observed at 21° C., all cells display similar overpotential behaviour. Nevertheless, the difference in the absolute value of the overpotentials at the negative plate is greater, and that at the positive plate is smaller, in cells operated at 45° C. Since the absolute value of the overpotential at the negative plate increases with increase in temperature, the negative plate will accept charge more effectively at elevated temperature. By contrast, the positive plate will receive charge less efficiently at elevated temperature because of the decrease in overpotential. This observation is in good agreement with the general acceptance that charging efficiency is better for negative plates than for positive plates at high temperature.

In practice, VRLA cells are usually charged at a voltage limit between 2.20 and 2.45 V. In this voltage range, the negative-plate overpotentials of cells using control oxide and oxides with specification I or specification II are between −0.01 and −0.05 V at 21° C. (FIG. 18) and −0.01 and −0.1 V at 45° C. (FIG. 19). Furthermore, the oxygen-recombination efficiencies of the cells are very high (i.e., 95 to 97%). Thus, it can be concluded that under prolonged float or normal charging conditions, these VRLA cells do not succumb to selective discharge of either the negative or the positive plates.

(ii) Float Current

The change in float current with temperature of VRLA cells using control oxide and oxides with either specification I or specification II is shown in FIG. 20. It is found that the float current increases with increase in cell temperature. This applies for all cells irrespective of the type of oxide employed. Nevertheless, the cell using oxide with specification I shows the lowest increase and that using oxide with specification II displays the greatest increase in float current with the increase of temperature.

In the foregoing description and in the claims, except where the context requires otherwise due to express language or necessary implication, the term “comprise” or variations such as “comprises” or “comprising” are used in an exclusive sense. It is noted that, in the context of elements being present in certain amounts, the term comprise does not permit there to be an excess of the element above the defined upper limit. It is also noted that various modifications may be made to the preferred embodiments described without departing from the scope of the invention as claimed.

### TABLES

Tables 1.

TABLE 2
Initial approximation of MALs - Upper Levels (1).

| | Lower Level* | Upper Level (1) |
|---|---|---|
| Residual element | (ppm) | (ppm) |
| Ni | <1.0 | 10.0 |
| Sb | <1.0 | 10.0 |
| Co | <1.0 | 10.0 |
| Cr | <1.0 | 5.0 |
| Fe | 1.3 | 10.0 |
| Mn | <1.0 | 3.0 |
| Cu | <1.0 | 10.0 |
| Ag | 4.0 | 20.0 |
| Se | <0.5 | 1.0 |
| Te | <0.3 | 0.3 |
| As | <1.0 | 10.0 |
| Sn | <1.0 | 10.0 |
| Bi | <1.0 | 500.0 |
| Ge | <1.0 | 500.0 |
| Zn | <1.0 | 500.0 |
| Cd | <1.0 | 500.0 |

*The Lower Levels are the concentrations of residual elements in Doe Run ‘control’ oxide. Note that, the lower level for Tl is 10 ppm (the upper level for this element was addressed later in the project).

TABLE 3
Plackett-Burman design of 16 elements (concentration, ppm) with repeat trials.

| Trial | | | | | | | | | | | | | | | | | Run |
|---|---|---|---|---|---|---|---|---|---|---|---|---|---|---|---|---|---|
| No. | Ni | Sb | Co | Cr | Fe | Mn | Cu | Ag | Se | Te | As | Sn | Bi | Ge | Zn | Cd | order |
| 1 | 0 | 0 | 0 | 0 | 0 | 0 | 0 | 0 | 0 | 0 | 0 | 0 | 0 | 0 | 0 | 0 | 1 |
| 2 | 10 | 10 | 10 | 5 | 10 | 3 | 10 | 20 | 1 | 0.3 | 10 | 10 | 500 | 500 | 500 | 500 | 2 |
| 3^{a} | 5 | 5 | 5 | 2.5 | 3 | 1.5 | 5 | 10 | 0.5 | 0.15 | 5 | 5 | 250 | 250 | 250 | 250 | 3 |
| 4 | 10 | 10 | 0 | 0 | 10 | 3 | 10 | 20 | 0 | 0.3 | 0 | 10 | 0 | 0 | 0 | 0 | 9 |
| 5 | 10 | 0 | 0 | 5 | 10 | 3 | 10 | 0 | 1 | 0 | 10 | 0 | 0 | 0 | 0 | 500 | 24 |
| 6 | 0 | 0 | 10 | 5 | 10 | 3 | 0 | 20 | 0 | 0.3 | 0 | 0 | 0 | 0 | 500 | 500 | 12 |
| 7 | 0 | 10 | 10 | 5 | 10 | 0 | 10 | 0 | 1 | 0 | 0 | 0 | 0 | 500 | 500 | 0 | 11 |
| 8 | 10 | 10 | 10 | 5 | 0 | 3 | 0 | 20 | 0 | 0 | 0 | 0 | 500 | 500 | 0 | 500 | 16 |
| 9 | 10 | 10 | 10 | 0 | 10 | 0 | 10 | 0 | 0 | 0 | 0 | 10 | 500 | 0 | 500 | 500 | 7 |
| 10 | 10 | 10 | 0 | 5 | 0 | 3 | 0 | 0 | 0 | 0 | 10 | 10 | 0 | 500 | 500 | 0 | 21 |
| 11 | 10 | 0 | 10 | 0 | 10 | 0 | 0 | 0 | 0 | 0.3 | 10 | 0 | 500 | 500 | 0 | 0 | 5 |
| 12 | 0 | 10 | 0 | 5 | 0 | 0 | 0 | 0 | 1 | 0.3 | 0 | 10 | 500 | 0 | 0 | 500 | 19 |
| 13^{b} | 0 | 0 | 0 | 0 | 0 | 0 | 0 | 0 | 0 | 0 | 0 | 0 | 0 | 0 | 0 | 0 | 13 |
| 14^{c} | 10 | 10 | 10 | 5 | 10 | 3 | 10 | 20 | 1 | 0.3 | 10 | 10 | 500 | 500 | 500 | 500 | 14 |
| 15 | 10 | 0 | 10 | 0 | 0 | 0 | 0 | 20 | 1 | 0 | 10 | 10 | 0 | 0 | 500 | 500 | 20 |
| 16 | 0 | 10 | 0 | 0 | 0 | 0 | 10 | 20 | 0 | 0.3 | 10 | 0 | 0 | 500 | 500 | 500 | 18 |
| 17 | 10 | 0 | 0 | 0 | 0 | 3 | 10 | 0 | 1 | 0.3 | 0 | 0 | 500 | 500 | 500 | 500 | 10 |
| 18 | 0 | 0 | 0 | 0 | 10 | 3 | 0 | 20 | 1 | 0 | 0 | 10 | 500 | 500 | 500 | 0 | 22 |
| 19 | 0 | 0 | 0 | 5 | 10 | 0 | 10 | 20 | 0 | 0 | 10 | 10 | 500 | 500 | 0 | 500 | 6 |
| 20 | 0 | 0 | 10 | 5 | 0 | 3 | 10 | 0 | 0 | 0.3 | 10 | 10 | 500 | 0 | 500 | 0 | 8 |
| 21 | 0 | 10 | 10 | 0 | 10 | 3 | 0 | 0 | 1 | 0.3 | 10 | 10 | 0 | 500 | 0 | 500 | 4 |
| 22 | 10 | 10 | 0 | 5 | 10 | 0 | 0 | 20 | 1 | 0.3 | 10 | 0 | 500 | 0 | 500 | 0 | 17 |
| 23 | 10 | 0 | 10 | 5 | 0 | 0 | 10 | 20 | 1 | 0.3 | 0 | 10 | 0 | 500 | 0 | 0 | 15 |
| 24 | 0 | 10 | 10 | 0 | 0 | 3 | 10 | 20 | 1 | 0 | 10 | 0 | 500 | 0 | 0 | 0 | 23 |
| 25^{b} | 0 | 0 | 0 | 0 | 0 | 0 | 0 | 0 | 0 | 0 | 0 | 0 | 0 | 0 | 0 | 0 | 26 |
| 26^{c} | 10 | 10 | 10 | 5 | 10 | 3 | 10 | 20 | 1 | 0.3 | 10 | 10 | 500 | 500 | 500 | 500 | 25 |
| 27^{d} | 0 | 0 | 10 | 5 | 10 | 3 | 0 | 20 | 0 | 0.3 | 0 | 0 | 0 | 0 | 500 | 500 | 27 |

^{a}All elements at mid levels
^{b}Repeat of trial #1
^{c}Repeat of trial #2
^{d}Repeat of trial #6

TABLE 4
Paste formulae for test electrodes.

| Component | Negative electrode | Positive electrode |
|---|---|---|
| Leady oxide (kg) | 1 | 1 |
| Fibre (g) | 0.6 | 0.3 |
| BaSO₄ (g) | 4.93 | — |
| Carbon back (g) | 0.26 | — |
| H₂SO₄, 1.400 rel.dens. (cm³) | 57 | 57 |
| Water (cm³) | 110 | 130 |
| Acid-to-oxide ratio (%) | 4 | 4 |
| Paste density (g cm⁻³) | 4.7 | 4.5 |

TABLE 5
Dimensions and composition of negative and positive grids.

| | Negative grid | Positive grid |
|---|---|---|
| Height (mm) | 68 | 68 |
| Width (mm) | 40 | 40 |
| Thickness (mm) | 3.3 | 3.3 |
| Composition | Pb-0.09 wt. % | Pb-0.09 wt. % Ca-0.8 wt. % Sn |
| | Ca-0.3 wt. % Sn | |

TABLE 6
Comparison of critical values with measured values of float,
hydrogen-evolution and oxygen-evolution currents.

| | Measured value | | | Δ(critical value − measured | | |
|---|---|---|---|---|---|---|
| | (mA Ah⁻¹) | | | value) (mA Ah⁻¹) | | |
| Trial # | I_{float} | I_{H}_{₂} | I_{O}_{₂} | I_{float} | I_{H}_{₂} | I_{O}_{₂} |
| 1 | 0.630 | 0.022 | 0.608 | +0.370 | +0.001 | +0.369 |
| 2 | 1.346 | 0.028 | 1.318 | −0.346 | −0.005 | −0.341 |
| 3^{a} | 0.722 | 0.024 | 0.698 | +0.278 | −0.001 | +0.279 |
| 4 | 0.962 | 0.021 | 0.941 | +0.038 | +0.002 | +0.036 |
| 5 | 1.019 | 0.041 | 0.978 | −0.019 | −0.018 | −0.001 |
| 6 | 0.577 | 0.020 | 0.557 | +0.423 | +0.003 | +0.420 |
| 7 | 0.659 | 0.010 | 0.649 | +0.341 | +0.013 | +0.328 |
| 8 | 1.128 | 0.010 | 1.118 | −0.128 | +0.013 | −0.141 |
| 9 | 0.612 | 0.011 | 0.601 | +0.388 | +0.012 | +0.376 |
| 10 | 0.965 | 0.010 | 0.955 | +0.035 | +0.013 | +0.022 |
| 11 | 0.635 | 0.022 | 0.613 | +0.365 | +0.001 | +0.364 |
| 12 | 0.630 | 0.028 | 0.602 | +0.370 | −0.005 | +0.375 |
| 13^{b} | 0.687 | 0.018 | 0.669 | +0.313 | +0.005 | +0.308 |
| 14^{c} | 1.288 | 0.026 | 1.262 | −0.288 | −0.003 | −0.285 |
| 15 | 1.125 | 0.020 | 1.110 | −0.125 | +0.003 | −0.133 |
| 16 | 0.993 | 0.018 | 0.975 | +0.007 | +0.005 | +0.002 |
| 17 | 1.299 | 0.021 | 1.278 | −0.299 | +0.002 | −0.301 |
| 18 | 0.933 | 0.013 | 0.919 | +0.067 | +0.010 | +0.058 |
| 19 | 0.687 | 0.020 | 0.667 | +0.313 | +0.003 | +0.310 |
| 20 | 0.557 | 0.020 | 0.537 | +0.443 | +0.003 | +0.440 |
| 21 | 0.862 | 0.027 | 0.835 | +0.138 | −0.004 | +0.142 |
| 22 | 0.469 | 0.008 | 0.461 | +0.531 | +0.015 | +0.516 |
| 23 | 1.130 | 0.028 | 1.102 | −0.130 | −0.005 | −0.125 |
| 24 | 0.661 | 0.028 | 0.633 | +0.339 | −0.005 | +0.344 |
| 25^{b} | 0.747 | 0.020 | 0.727 | +0.253 | +0.003 | +0.250 |
| 26^{c} | 1.233 | 0.026 | 1.207 | −0.233 | −0.003 | −0.230 |
| 27^{d} | 0.516 | 0.016 | 0.500 | +0.484 | +0.007 | +0.477 |

^{a}All elements at mid levels
^{b}Repeat of trial #1
^{c}Repeat of trial #2
^{d}Repeat of trial #6

TABLE 7
Statistical analysis of sets of repeated measurements.

| | Measured value (mA Ah⁻¹) | | |
|---|---|---|---|
| Trial # | I_{float} | I_{H}_{₂} | I_{O}_{₂} |

Repeats of control oxide

| | | | |
|---|---|---|---|
| 1 | 0.630 | 0.022 | 0.608 |
| 13 | 0.687 | 0.018 | 0.669 |
| 25 | 0.747 | 0.020 | 0.727 |
| 28 (see, Table 13) | 0.778 | 0.020 | 0.758 |
| Average, m | 0.711 | 0.020 | 0.691 |
| Variance | 0.431 × 10⁻² | 2.700 × 10⁻⁶ | 0.439 × 10⁻² |
| Standard deviation, s | 6.563 × 10⁻² | 1.630 × 10⁻³ | 6.622 × 10⁻² |
| Degrees of freedom | 3 | 3 | 3 |
| Repeats of oxide with | | | |
| all elements at | | | |
| high levels | | | |
| 2 | 1.364 | 0.028 | 1.318 |
| 14 | 1.288 | 0.026 | 1.262 |
| 26 | 1.233 | 0.026 | 1.207 |
| Average, m | 1.289 | 0.027 | 1.262 |
| Variance | 0.319 × 10⁻² | 1.330 × 10⁻⁶ | 5.550 × 10⁻² |
| Standard deviation, s | 5.651 × 10⁻² | 1.155 × 10⁻³ | 3.960 × 10⁻² |
| Degrees of Freedom | 2 | 2 | 2 |
| Repeats of trial #6 | | | |
| 6 | 0.577 | 0.020 | 0.557 |
| 27 | 0.516 | 0.016 | 0.500 |
| Average, m | 0.547 | 0.018 | 0.529 |
| Variance | 0.186 × 10⁻² | 8.000 × 10⁻⁶ | 0.162 × 10⁻² |
| Standard deviation, s | 4.313 × 10⁻² | 2.828 × 10⁻³ | 4.031 × 10⁻² |
| Degrees of freedom | 1 | 1 | 1 |
| Pooled values | | | |
| Variance | 0.353 × 10⁻² | 3.110 × 10⁻⁶ | 0.349 × 10⁻² |
| Standard deviation, s | 5.940 × 10⁻² | 1.764 × 10⁻³ | 5.908 × 10⁻² |
| Uncertainty, ± | 6.500 × 10⁻² | 1.930 × 10⁻³ | 6.465 × 10⁻² |
| Degrees of freedom | 6 | 6 | 6 |

TABLE 8
Trials to determine the rate of change of individual elements.

| Trial # | Ni | Sb | Co | Cr | Fe | Mn | Cu | Ag | Se | Te | As | Sn | Bi | Ge | Zn | Cd |
|---|---|---|---|---|---|---|---|---|---|---|---|---|---|---|---|---|
| 1 | 0 | 0 | 0 | 0 | 0 | 0 | 0 | 0 | 0 | 0 | 0 | 0 | 0 | 0 | 0 | 0 |
| 4 | 10 | 10 | 0 | 0 | 10 | 3 | 10 | 20 | 0 | 0.3 | 0 | 10 | 0 | 0 | 0 | 0 |
| 5 | 10 | 0 | 0 | 5 | 10 | 3 | 10 | 0 | 1 | 0 | 10 | 0 | 0 | 0 | 0 | 500 |
| 6 | 0 | 0 | 10 | 5 | 10 | 3 | 0 | 20 | 0 | 0.3 | 0 | 0 | 0 | 0 | 500 | 500 |
| 7 | 0 | 10 | 10 | 5 | 10 | 0 | 10 | 0 | 1 | 0 | 0 | 0 | 0 | 500 | 500 | 0 |
| 8 | 10 | 10 | 10 | 5 | 0 | 3 | 0 | 20 | 0 | 0 | 0 | 0 | 500 | 500 | 0 | 500 |
| 9 | 10 | 10 | 10 | 0 | 10 | 0 | 10 | 0 | 0 | 0 | 0 | 10 | 500 | 0 | 500 | 500 |
| 10 | 10 | 10 | 0 | 5 | 0 | 3 | 0 | 0 | 0 | 0 | 10 | 10 | 0 | 500 | 500 | 0 |
| 11 | 10 | 0 | 10 | 0 | 10 | 0 | 0 | 0 | 0 | 0.3 | 10 | 0 | 500 | 500 | 0 | 0 |
| 12 | 0 | 10 | 0 | 5 | 0 | 0 | 0 | 0 | 1 | 0.3 | 0 | 10 | 500 | 0 | 0 | 500 |
| 15 | 10 | 0 | 10 | 0 | 0 | 0 | 0 | 20 | 1 | 0 | 10 | 10 | 0 | 0 | 500 | 500 |
| 16 | 0 | 10 | 0 | 0 | 0 | 0 | 10 | 20 | 0 | 0.3 | 10 | 0 | 0 | 500 | 500 | 500 |
| 17 | 10 | 0 | 0 | 0 | 0 | 3 | 10 | 0 | 1 | 0.3 | 0 | 0 | 500 | 500 | 500 | 500 |
| 18 | 0 | 0 | 0 | 0 | 10 | 3 | 0 | 20 | 1 | 0 | 0 | 10 | 500 | 500 | 500 | 0 |
| 19 | 0 | 0 | 0 | 5 | 10 | 0 | 10 | 20 | 0 | 0 | 10 | 10 | 500 | 500 | 0 | 500 |
| 20 | 0 | 0 | 10 | 5 | 0 | 3 | 10 | 0 | 0 | 0.3 | 10 | 10 | 500 | 0 | 500 | 0 |
| 21 | 0 | 10 | 10 | 0 | 10 | 3 | 0 | 0 | 1 | 0.3 | 10 | 10 | 0 | 500 | 0 | 500 |
| 22 | 10 | 10 | 0 | 5 | 10 | 0 | 0 | 20 | 1 | 0.3 | 10 | 0 | 500 | 0 | 500 | 0 |
| 23 | 10 | 0 | 10 | 5 | 0 | 0 | 10 | 20 | 1 | 0.3 | 0 | 10 | 0 | 500 | 0 | 0 |
| 24 | 0 | 10 | 10 | 0 | 0 | 3 | 10 | 20 | 1 | 0 | 10 | 0 | 500 | 0 | 0 | 0 |

TABLE 9
Rates of change of float, hydrogen and oxygen currents of 16 elements.

| | | Average value (mA Ah⁻¹) | | | Rate of change (mA Ah⁻¹ per ppm) | | |
|---|---|---|---|---|---|---|---|
| Elements | Level (ppm) | I_{float} | I_{hydrogen} | I_{oxygen} | I_{float} | I_{hydrogen} | I_{oxygen} |
| Ni | 10 | 0.9344 | 0.0192 | 0.9157 | +0.02155 | −0.00140 | +0.02175 |
| | 0 | 0.7189 | 0.0206 | 0.6982 | | | |
| Sb | 10 | 0.7941 | 0.0171 | 0.7770 | −0.00651 | −0.00056 | −0.00599 |
| | 0 | 0.8592 | 0.0227 | 0.8369 | | | |
| Co | 10 | 0.7946 | 0.0196 | 0.7755 | −0.00641 | −0.00006 | −0.00629 |
| | 0 | 0.8587 | 0.0202 | 0.8384 | | | |
| Cr | 5 | 0.7821 | 0.0195 | 0.7626 | −0.01782 | −0.00016 | −0.01774 |
| | 0 | 0.8712 | 0.0203 | 0.8513 | | | |
| Fe | 10 | 0.7415 | 0.0193 | 0.7221 | −0.01958 | −0.00014 | −0.01951 |
| | 1.3 | 0.9118 | 0.0205 | 0.8918 | | | |
| Mn | 3 | 0.8963 | 0.0211 | 0.8751 | +0.04643 | +0.00080 | +0.04543 |
| | 0 | 0.7570 | 0.0187 | 0.7388 | | | |
| Cu | 10 | 0.8579 | 0.0218 | 0.8361 | +0.00625 | +0.00038 | +0.00583 |
| | 0 | 0.7954 | 0.0180 | 0.7778 | | | |
| Ag | 20 | 0.8665 | 0.0186 | 0.8483 | +0.00498 | −0.00016 | +0.00517 |
| | 4 | 0.7868 | 0.0212 | 0.7656 | | | |
| Se | 1 | 0.8787 | 0.0224 | 0.8567 | +0.10410 | +0.00500 | +0.09950 |
| | 0 | 0.7746 | 0.0174 | 0.7572 | | | |
| Te | 0.3 | 0.8114 | 0.0213 | 0.7901 | −0.10167 | +0.00933 | −0.11233 |
| | 0 | 0.8419 | 0.0185 | 0.8238 | | | |
| As | 10 | 0.7973 | 0.0214 | 0.7764 | −0.00587 | +0.00030 | −0.00611 |
| | 0 | 0.8560 | 0.0184 | 0.8375 | | | |
| Sn | 10 | 0.8463 | 0.0198 | 0.8269 | +0.00393 | −0.00002 | +0.00399 |
| | 0 | 0.8070 | 0.0200 | 0.7870 | | | |
| Bi | 500 | 0.7611 | 0.0181 | 0.7429 | −0.00026 | −0.00001 | −0.00026 |
| | 0 | 0.8922 | 0.0217 | 0.8710 | | | |
| Ge | 500 | 0.9291 | 0.0179 | 0.9111 | +0.00041 | −0.00001 | +0.00042 |
| | 0 | 0.7242 | 0.0219 | 0.7028 | | | |
| Zn | 500 | 0.8189 | 0.0151 | 0.8042 | −0.00003 | −0.00002 | −0.00001 |
| | 0 | 0.8344 | 0.0247 | 0.8097 | | | |
| Cd | 500 | 0.8932 | 0.0216 | 0.8721 | +0.00027 | +0.00001 | +0.00026 |
| | 0 | 0.7601 | 0.0182 | 0.7418 | | | |

TABLE 10
Grouping of trials that deliver hydrogen current (mA Ah⁻¹) greater/lower than critical value.

| Trial # | I_{hydrogen} | Ni | Sb | Co | Cr | Fe | Mn | Cu | Ag | Se | Te | As | Sn | Bi | Ge | Zn | Cd |
|---|---|---|---|---|---|---|---|---|---|---|---|---|---|---|---|---|---|
| 5 | 0.041 | H | L | L | H | H | H | H | L | H | L | H | L | L | L | L | H |
| 23 | 0.028 | H | L | H | H | L | L | H | H | H | H | L | H | L | H | L | L |
| 24 | 0.028 | L | H | H | L | L | H | H | H | H | L | H | L | H | L | L | L |
| 12 | 0.028 | L | H | L | H | L | L | L | L | H | H | L | H | H | L | L | H |
| 21 | 0.027 | L | H | H | L | H | H | L | L | H | H | H | H | L | H | L | H |
| Total trials | | 5 | 5 | 5 | 5 | 5 | 5 | 5 | 5 | 5 | 5 | 5 | 5 | 5 | 5 | 5 | 5 |
| Frequency^{a} | | 2 | 3 | 3 | 3 | 2 | 3 | 3 | 2 | 5 | 3 | 3 | 3 | 2 | 2 | 0 | 3 |
| CV^{b} | 0.023 | | | | | | | | | | | | | | | | |
| 11 | 0.022 | H | L | H | L | H | L | L | L | L | H | H | L | H | H | L | L |
| 17 | 0.021 | H | L | L | L | L | H | H | L | H | H | L | L | H | H | H | H |
| 4 | 0.021 | H | H | L | L | H | H | H | H | L | H | L | H | L | L | L | L |
| 15 | 0.020 | H | L | H | L | L | L | L | H | H | L | H | H | L | L | H | H |
| 19 | 0.020 | L | L | L | H | H | L | H | H | L | L | H | H | H | H | L | H |
| 6 | 0.020 | L | L | H | H | H | H | L | H | L | H | L | L | L | L | H | H |
| 20 | 0.020 | L | L | H | H | L | H | H | L | L | H | H | H | H | L | H | L |
| 16 | 0.018 | L | H | L | L | L | L | H | H | L | H | H | L | L | H | H | H |
| 18 | 0.013 | L | L | L | L | H | H | L | H | H | L | L | H | H | H | H | L |
| 9 | 0.011 | H | H | H | L | H | L | H | L | L | L | L | H | H | L | H | H |
| 8 | 0.010 | H | H | H | H | L | H | L | H | L | L | L | L | H | H | L | H |
| 10 | 0.010 | H | H | L | H | L | H | L | L | L | L | H | H | L | H | H | L |
| 7 | 0.010 | L | H | H | H | H | L | H | L | H | L | L | L | L | H | H | L |
| 22 | 0.008 | H | H | L | H | H | L | L | H | H | H | H | L | H | L | H | L |
| Total trials | | 14 | 14 | 14 | 14 | 14 | 41 | 14 | 14 | 14 | 14 | 14 | 14 | 14 | 14 | 14 | 14 |
| Frequency^{a} | | 8 | 7 | 7 | 7 | 8 | 7 | 7 | 8 | 5 | 7 | 7 | 7 | 8 | 8 | 10 | 7 |

^{a}Frequency of presence of a given element
^{b}Critical value

TABLE 11
Grouping of trials that deliver oxygen current (mA Ah⁻¹) greater or lower than critical value.

| Trial # | I_{oxygen} | Ni | Sb | Co | Cr | Fe | Mn | Cu | Ag | Se | Te | As | Sn | Bi | Ge | Zn | Cd |
|---|---|---|---|---|---|---|---|---|---|---|---|---|---|---|---|---|---|
| 17 | 1.278 | H | L | L | L | L | H | H | L | H | H | L | L | H | H | H | H |
| 8 | 1.118 | H | H | H | H | L | H | L | H | L | L | L | L | H | H | L | H |
| 15 | 1.110 | H | L | H | L | L | L | L | H | H | L | H | H | L | L | H | H |
| 23 | 1.102 | H | L | H | H | L | L | H | H | H | H | L | H | L | H | L | L |
| 5 | 0.978 | H | L | L | H | H | H | H | L | H | L | H | L | L | L | L | H |
| Total trials | | 5 | 5 | 5 | 5 | 5 | 5 | 5 | 5 | 5 | 5 | 5 | 5 | 5 | 5 | 5 | 5 |
| Frequency^{a} | | 5 | 1 | 3 | 3 | 1 | 3 | 3 | 3 | 4 | 2 | 2 | 2 | 2 | 3 | 2 | 4 |
| CV^{b} | 0.977 | | | | | | | | | | | | | | | | |
| 16 | 0.975 | L | H | L | L | L | L | H | H | L | H | H | L | L | H | H | H |
| 10 | 0.955 | H | H | L | H | L | H | L | L | L | L | H | H | L | H | H | L |
| 4 | 0.941 | H | H | L | L | H | H | H | H | L | H | L | H | L | L | L | L |
| 18 | 0.919 | L | L | L | L | H | H | L | H | H | L | L | H | H | H | H | L |
| 21 | 0.835 | L | H | H | L | H | H | L | L | H | H | H | H | L | H | L | H |
| 19 | 0.667 | L | L | L | H | H | L | H | H | L | L | H | H | H | H | L | H |
| 7 | 0.649 | L | H | H | H | H | L | H | L | H | L | L | L | L | H | H | L |
| 24 | 0.633 | L | H | H | L | L | H | H | H | H | L | H | L | H | L | L | L |
| 11 | 0.613 | H | L | H | L | H | L | L | L | L | H | H | L | H | H | L | L |
| 12 | 0.602 | L | H | L | H | L | L | L | L | H | H | L | H | H | L | L | H |
| 9 | 0.601 | H | H | H | L | H | L | H | L | L | L | L | H | H | L | H | H |
| 6 | 0.557 | L | L | H | H | H | H | L | H | L | H | L | L | L | L | H | H |
| 20 | 0.537 | L | L | H | H | L | H | H | L | L | H | H | H | H | L | H | L |
| 22 | 0.461 | H | H | L | H | H | L | L | H | H | H | H | L | H | L | H | L |
| Total trials | | 14 | 14 | 14 | 14 | 14 | 41 | 14 | 14 | 14 | 14 | 14 | 14 | 14 | 14 | 14 | 14 |
| Frequency^{a} | | 5 | 9 | 7 | 7 | 9 | 7 | 7 | 7 | 6 | 8 | 8 | 8 | 8 | 7 | 8 | 6 |

^{a}Frequency of presence of a given element
^{b}Critical value

TABLE 12
Second Plackett-Burman design of seven elements (ppm).

| Trial # | Ni | Sb | Co | Ag | As | Sn | Ge |
|---|---|---|---|---|---|---|---|
| 28^{a} | 0 | 0 | 0 | 0 | 0 | 0 | 0 |
| 29 | 5 | 5 | 5 | 80 | 15 | 80 | 500 |
| 30 | 2.5 | 2.5 | 2.5 | 40 | 7.5 | 40 | 250 |
| 31^{b} | 0 | 0 | 0 | 0 | 0 | 0 | 500 |
| 32 | 5 | 5 | 5 | 0 | 0 | 0 | 500 |
| 33 | 0 | 5 | 5 | 80 | 15 | 0 | 0 |
| 34 | 0 | 0 | 5 | 0 | 15 | 80 | 500 |
| 35 | 5 | 0 | 0 | 80 | 15 | 0 | 500 |
| 36 | 0 | 5 | 0 | 80 | 0 | 80 | 500 |
| 37 | 5 | 0 | 5 | 80 | 0 | 80 | 0 |
| 38 | 5 | 5 | 0 | 0 | 15 | 80 | 0 |

^{a}Control oxide
^{b}Evaluating only the effect of germanium

TABLE 13
Comparison of critical values with measured values of float,
hydrogen and oxygen currents.

| | Measured value | | | Δ(critical value − measured | | |
|---|---|---|---|---|---|---|
| | (mA Ah⁻¹) | | | value) (mA Ah⁻¹) | | |
| Trial # | I_{float} | I_{hydrogen} | I_{oxygen} | I_{float} | I_{hydrogen} | I_{oxygen} |

| | | | | | | |
|---|---|---|---|---|---|---|
| 28 | 0.778 | 0.020 | 0.758 | +0.222 | +0.003 | +0.219 |
| 29 | 1.107 | 0.039 | 1.068 | −0.107 | −0.016 | −0.091 |
| 30 | 0.804 | 0.011 | 0.793 | +0.196 | +0.012 | +0.184 |
| 31 | 0.757 | 0.026 | 0.731 | +0.243 | −0.003 | +0.246 |
| 32 | 1.141 | 0.013 | 1.128 | −0.141 | +0.010 | −0.151 |
| 33 | 0.987 | 0.019 | 0.968 | +0.023 | +0.004 | +0.009 |
| 34 | 0.991 | 0.011 | 0.979 | +0.009 | +0.012 | −0.002 |
| 35 | 0.926 | 0.011 | 0.915 | +0.074 | +0.012 | +0.062 |
| 36 | 0.676 | 0.012 | 0.664 | +0.324 | +0.011 | +0.313 |
| 37 | 0.976 | 0.016 | 0.960 | +0.024 | +0.007 | +0.017 |
| 38 | 0.982 | 0.010 | 0.972 | +0.018 | +0.013 | +0.005 |

TABLE 14
Levels of elements at which measured float, hydrogen and
oxygen currents are equal to their corresponding critical values.

| | | | Measured value | | | | | |
|---|---|---|---|---|---|---|---|---|
| | | Upper | (mA Ah⁻¹) | | | Level (ppm) | | |
| Trial # | Elements | Level (3) (ppm) | I_{float} | I_{hydrogen} | I_{oxygen} | I_{float} | I_{hydrogen} | I_{oxygen} |
| 39 | Tl | 30 | 1.103 | 0.024 | 1.077 | 25 | 25 | 25 |
| 40 | As | 15 | 1.547 | 0.020 | 1.527 | 5 | — | 5 |
| 41 | Bi | 500 | 0.977 | 0.012 | 0.965 | 543 | — | 522 |
| 42 | Cd | 500 | 0.902 | 0.013 | 0.889 | 756 | — | 722 |
| 43 | Fe | 10 | 0.673 | 0.013 | 0.660 | — | — | — |
| 44 | Sn | 48 | 1.053 | 0.018 | 1.035 | 41 | — | 40 |
| 45 | Zn | 500 | 0.869 | 0.020 | 0.849 | 915 | — | 905 |

TABLE 15
MALs of residual elements.

| | Level (ppm) | | | |
|---|---|---|---|---|
| Elements | I_{float} | I_{hydrogen} | I_{oxygen} | MAL (ppm) |
| Ni | 4 | 16 | 4 | 4 |
| Sb | 6 | 5 | 6 | 6 |
| Co | 4 | 7 | 4 | 4 |
| Cr | 7 | 16 | 7 | 7 |
| Fe | — | — | — | 10 |
| Mn | 5 | 5 | 5 | 5 |
| Cu | 33 | 13 | 34 | 34 |
| Ag | 76 | 142 | 66 | 66 |
| Se | 2 | 1 | 2 | 1 |
| Te | 1.5 | 0.5 | 1.4 | 0.5 |
| Tl | 25 | 25 | 25 | 25 |
| As | 5 | — | 5 | 5 |
| Sn | 41 | — | 40 | 40 |
| Bi | 543 | — | 522 | 500 |
| Ge | 673 | 250 | 658 | 10 |
| Zn | 915 | — | 905 | 500 |
| Cd | 756 | — | 722 | 500 |

TABLE 16
Measured values of float, hydrogen and oxygen currents
of control oxide and oxides with specifications I and II.

| | Measured value | | | Oxygen | Δ(Critical value − measured | | |
|---|---|---|---|---|---|---|---|
| | (mA Ah⁻¹) | | | recomb. | value) (mA Ah⁻¹) | | |
| Oxide | I_{float} | I_{H}_{₂} | I_{O}_{₂} | (%) | I_{float} | I_{H}_{₂} | I_{O}_{₂} |
| Under | | | | | | | |
| 21° C. | | | | | | | |
| Control | 0.711 | 0.020 | 0.691 | 96 | +0.289 | +0.003 | +0.286 |
| Specification | 0.927 | 0.020 | 0.907 | 96 | +0.073 | +0.003 | +0.070 |
| I | | | | | | | |
| Specification | 0.814 | 0.020 | 0.793 | 95 | +0.186 | +0.002 | +0.184 |
| II | | | | | | | |
| Under | | | | | | | |
| 45° C. | | | | | | | |
| Control | 7.512 | 0.150 | 7.362 | 95 | — | — | — |
| Specification | 4.155 | 0.135 | 4.020 | 97 | — | — | — |
| I | | | | | | | |
| Specification | 8.946 | 0.145 | 8.701 | 95 | — | — | — |
| II | | | | | | | |

### REFERENCES

1. W. B. Brecht, Batteries International, 20 (1994) 40-43.

2. D. Berndt and W. E. M. Jones, Proceedings INTELEC '98, San Fransico, USA, 1998, pp. 443-451.

3. J. S. Symanski, B. K. Mahato and K. R. Bullock, J. Electrochem. Soc., 135 (1988) 548-551.

4. P. Ruetschi, R. T. Angstadt and B. D. Cahan, J. Electrochem. Soc., 106 (1959) 547-551.

5. S. Fletcher and D. B. Matthews, J. Appl. Electrochem., 11 (1981) 23-32.

6. L. T. Lam, J. D. Douglas, R. Pillig and D. A. J. Rand, J. Power Sources, 48 (1994) 219-232.

7. B. K. Mahato and W. H. Tiedemann, J. Electrochem. Soc., 130 (1983) 2139.

8. H. Sanchez, Y. Meas, I. Gonzales and M. S. Quiroz, J. Power Sources, 32 (1993) 43-53.

9. M. Maja and N. Penzzi, J. Power Sources, 22 (1988) 1-9.

10. J. R. Pierson, C. E. Weinlein and C. E. Wright, in D. H. Collins (ed.), Power Sources 5. Research and Development in Non-Mechanical Electrical Power Sources, Academic Press, New York, 1975, p. 97.

1. A lead composition for use in the production of battery components, the lead composition comprising
lead
20-100 ppm silver
250-1000 ppm bismuth, and
250-1000 ppm zinc.

2. The lead composition of claim 1, wherein the lead is in metal or oxide form, or in a mixture of forms.

3. The lead composition of claim 2, wherein the lead is in metal form.

4. The lead composition of claim 2, wherein the lead is predominantly in the form of lead oxide.

5. The lead composition of claim 1, wherein the silver, bismuth and zinc are each present in metal form, or as a compound with one or more other elements.

6. The lead composition of claim 1, wherein the level of bismuth in the lead composition is between 250-700 ppm.

7. The lead composition of claim 1, wherein the level of bismuth in the lead composition is between 250-500 ppm.

8. The lead composition of claim 1, wherein the level of zinc in the lead composition is between 250-700 ppm.

9. The lead composition of claim 1, wherein the level of zinc in the lead composition is between 250-500 ppm.

10. The lead composition of claim 1, wherein the level of silver is between 20-70 ppm.

11. The lead composition of claim 1, wherein the level of silver is between 20-66 ppm.

12. The lead composition of claim 1, wherein the lead composition comprises cadmium at a level of up to 1000 ppm.

13. The lead composition of claim 1, wherein the lead composition comprises cadmium at a level of 0-500 ppm.

14. The lead composition of claim 12, wherein cadmium is present at a minimum level of 20 ppm.

15. The lead composition of claim 1, wherein the lead composition comprises tin at a level of 5-80 ppm.

16. The lead composition of claim 1, wherein the lead composition comprises not more than 10 ppm cobalt, 15 ppm chromium, 5 ppm manganese, 3 ppm selenium, 5 ppm tellurium, 250 ppm germanium, and 20 ppm thallium.

17. The lead composition of claim 1, wherein lead composition comprises not more than 10 ppm nickel, 10 ppm antimony, 20 ppm iron, 20 ppm copper and 20 ppm arsenic.

18. The lead composition of claim 1, wherein the lead composition comprises not more than 2 ppm cobalt, 4 ppm chromium, 1.5 ppm manganese, 0.5 ppm selenium, 0.15 ppm tellurium, 10 ppm germanium, and 12 ppm thallium.

19. The lead composition of claim 18, wherein the lead composition comprises not more than 2 ppm nickel, 2 ppm antimony, 5 ppm iron, 5 ppm copper and 4 ppm arsenic.

20. A lead composition comprising:
lead;
silver, bismuth, zinc and tin in the following amounts:

| | |
|---|---|
| Ag | 20-100 ppm |
| Bi | 250-1000 ppm |
| Zn | 250-1000 ppm |
| Sn | 5-80 ppm |

and not more than the given amounts of the following elements measured in ppm:

| | |
|---|---|
| Ni | 10 |
| Sb | 10 |
| Co | 10 |
| Cr | 15 |
| Fe | 20 |
| Mn | 5 |
| Cu | 20 |
| Se | 3 |
| Te | 5 |
| As | 20 |
| Ge | 250 |
| Tl | 20 |
| Cd | 1000. |

21. The lead composition of claim 20, wherein the lead composition contains not more than the following amounts for at least 8 of the 13 elements set out in the following list:

| | |
|---|---|
| Ni | 2 |
| Sb | 2 |
| Co | 2 |
| Cr | 4 |
| Fe | 5 |
| Mn | 1.5 |
| Cu | 5 |
| Se | 0.5 |
| Te | 0.15 |
| As | 4 |
| Ge | 10 |
| Tl | 12 |
| Cd | 700. |

22. A lead composition comprising:
lead;
silver, bismuth, zinc and tin in the following amounts:

| | |
|---|---|
| Ag | 20-70 ppm |
| Bi | 250-700 ppm |
| Zn | 250-700 ppm |
| Sn | 5-40 ppm |

and not more than the given amounts of the following elements measured in ppm:

| | |
|---|---|
| Ni | 2 |
| Sb | 2 |
| Co | 2 |
| Cr | 4 |
| Fe | 5 |
| Mn | 1.5 |
| Cu | 5 |
| Se | 0.5 |
| Te | 0.15 |
| As | 4 |
| Ge | 10 |
| Tl | 12 |
| Cd | 700 |

23. The lead composition of claim 1, wherein the lead composition is in the form of a lead metal, a lead oxide powder, a lead-containing paste or a cured lead coating.

24. A battery plate comprising a coating of a lead composition, the lead composition comprising:
lead
20-100 ppm silver
250-1000 ppm bismuth, and
250-1000 ppm zinc.

25. A battery plate comprising a coating formed from a lead composition comprising:
lead;
silver, bismuth, zinc and tin in the following amounts:

| | |
|---|---|
| Ag | 20-100 ppm |
| Bi | 250-1000 ppm |
| Zn | 250-1000 ppm |
| Sn | 5-80 ppm |

and not more than the given amounts of the following elements measured in ppm:

| | |
|---|---|
| Ni | 10 |
| Sb | 10 |
| Co | 10 |
| Cr | 15 |
| Fe | 20 |
| Mn | 5 |
| Cu | 20 |
| Se | 3 |
| Te | 5 |
| As | 20 |
| Ge | 250 |
| Tl | 20 |
| Cd | 1000 |

26. A battery plate comprising a coating formed from a lead composition comprising:
lead;
silver, bismuth, zinc and tin in the following amounts:

| | |
|---|---|
| Ag | 20-70 ppm |
| Bi | 250-700 ppm |
| Zn | 250-700 ppm |
| Sn | 5-40 ppm |

and not more than the given amounts of the following elements measured in ppm:

| | |
|---|---|
| Ni | 2 |
| Sb | 2 |
| Co | 2 |
| Cr | 4 |
| Fe | 5 |
| Mn | 1.5 |
| Cu | 5 |
| Se | 0.5 |
| Te | 0.15 |
| As | 4 |
| Ge | 10 |
| Tl | 12 |
| Cd | 700 |

27. A battery comprising at least one battery plate with a coating of a lead lead composition comprising:
lead
20-100 ppm silver
250-1000 ppm bismuth, and
250-1000 ppm zinc.

28. A battery comprising a battery case, electrolyte and at least two battery plates, wherein said battery plates are coated with a lead composition comprising
lead;
silver, bismuth, zinc and tin in the following amounts:

| | |
|---|---|
| Ag | 20-100 ppm |
| Bi | 250-1000 ppm |
| Zn | 250-1000 ppm |
| Sn | 5-80 ppm |

and not more than the given amounts of the following elements measured in ppm:

| | |
|---|---|
| Ni | 10 |
| Sb | 10 |
| Co | 10 |
| Cr | 15 |
| Fe | 20 |
| Mn | 5 |
| Cu | 20 |
| Se | 3 |
| Te | 5 |
| As | 20 |
| Ge | 250 |
| Tl | 20 |
| Cd | 1000 |

29. A battery comprising a battery case, electrolyte and at least two battery plates, wherein said battery plates are coated with a lead composition comprising
lead;
silver, bismuth, zinc and tin in the following amounts:

| | |
|---|---|
| Ag | 20-70 ppm |
| Bi | 250-700 ppm |
| Zn | 250-700 ppm |
| Sn | 5-40 ppm |

and not more than the given amounts of the following elements measured in ppm:

| | |
|---|---|
| Ni | 2 |
| Sb | 2 |
| Co | 2 |
| Cr | 4 |
| Fe | 5 |
| Mn | 1.5 |
| Cu | 5 |
| Se | 0.5 |
| Te | 0.15 |
| As | 4 |
| Ge | 10 |
| Tl | 12 |
| Cd | 700 |

30. A lead composition for use in the production of positive battery plates comprising:
lead
100-1000 ppm antimony
100-1000 ppm iron.

31. The lead composition of claim 30, wherein the lead composition comprises less than 700 ppm zinc.

32. The lead composition of claim 30, wherein the lead composition comprises between 250-700 ppm bismuth and 250-700 ppm zinc.

33. A lead composition for use in the production of negative battery plates comprising:
lead
250-1000 ppm bismuth
250-1000 ppm zinc and
20-100 ppm silver,
and not more than 20 ppm antimony and not more than 30 ppm iron.

34. The lead composition of claim 33, wherein the level of bismuth is 250-700 ppm, and the level of silver is 20-70 ppm.

35. The lead composition of claim 33, wherein the level of antimony and iron in the lead composition is not more than 2 ppm antimony and 5 ppm iron.

36. A lead composition for use in the production of pastes for positive battery plates comprising:
lead;
100-1000 ppm antimony
100-1000 ppm iron;
and not more than the given amounts of the following elements, measured in ppm:

| | |
|---|---|
| Bi | 1000 |
| Zn | 1000 |
| Cd | 1000 |
| Sn | 80 |
| Ni | 10 |
| Co | 10 |
| Cr | 15 |
| Mn | 5 |
| Cu | 20 |
| Ag | 100 |
| Se | 3 |
| Te | 5 |
| As | 20 |
| Ge | 250 |
| Tl | 20. |

37. The lead composition of claim 36, wherein the lead composition comprises not more than the following amounts for at least 10 elements set out in the following list:

| | |
|---|---|
| Bi | 700 |
| Zn | 700 |
| Cd | 500 |
| Sn | 50 |
| Ni | 2 |
| Co | 2 |
| Cr | 4 |
| Mn | 1.5 |
| Cu | 5 |
| Ag | 66 |
| Se | 0.5 |
| Te | 0.15 |
| As | 4 |
| Ge | 10 |
| Tl | 12 |

38. A lead composition for use in the production of pastes for positive battery plates comprising:
lead
100-1000 ppm antimony
100-1000 ppm iron
and not more than the given amounts of the following elements, measured in ppm:

| | |
|---|---|
| Bi | 700 |
| Zn | 700 |
| Cd | 500 |
| Sn | 50 |
| Ni | 2 |
| Co | 2 |
| Cr | 4 |
| Mn | 1.5 |
| Cu | 5 |
| Ag | 66 |
| Se | 0.5 |
| Te | 0.15 |
| As | 4 |
| Ge | 10 |
| Tl | 12. |

39. A lead composition for use in the production of pastes for negative battery plates comprising:
lead
250-1000 ppm Bi
250-1000 ppm Zn
20-100 ppm Ag
and not more than the given amounts of the following elements measure in ppm:

| | |
|---|---|
| Sb | 10 |
| Fe | 20 |
| Sn | 80 |
| Cd | 1000 |
| Ni | 10 |
| Co | 10 |
| Cr | 15 |
| Mn | 5 |
| Cu | 20 |
| Se | 3 |
| Te | 5 |
| As | 20 |
| Ge | 250 |
| Tl | 20 |

40. The lead composition of claim 39, wherein the lead composition contains not more than the following amounts for at least 9 of the 14 elements set out in the following list:

| | |
|---|---|
| Sb | 10 |
| Fe | 20 |
| Sn | 80 |
| Cd | 1000 |
| Ni | 10 |
| Co | 10 |
| Cr | 15 |
| Mn | 5 |
| Cu | 20 |
| Se | 3 |
| Te | 5 |
| As | 20 |
| Ge | 250 |
| Tl | 20 |

41. A lead composition for use in the production of pastes for negative battery plates comprising
lead
250-700 ppm Bi
250-1000 ppm Zn
40-66 ppm Ag
and not more than the given amounts of the following elements measure in ppm:

| | |
|---|---|
| Sb | 2 |
| Fe | 5 |
| Sn | 50 |
| Cd | 500 |
| Ni | 2 |
| Co | 2 |
| Cr | 4 |
| Mn | 1.5 |
| Cu | 5 |
| Se | 0.5 |
| Te | 0.15 |
| As | 4 |
| Ge | 10 |
| Tl | 12 |

42. A positive battery plate comprising a coating of a lead composition comprising:
lead
100-1000 ppm antimony
100-1000 ppm iron

43. A positive battery plate comprising a coating of a lead composition comprising:
lead
100-1000 ppm antimony
100-1000 ppm iron
and not more than the given amounts of the following elements, measured in ppm:

| | |
|---|---|
| Bi | 1000 |
| Zn | 1000 |
| Cd | 1000 |
| Sn | 80 |
| Ni | 10 |
| Co | 10 |
| Cr | 15 |
| Mn | 5 |
| Cu | 20 |
| Ag | 100 |
| Se | 3 |
| Te | 5 |
| As | 20 |
| Ge | 250 |
| Tl | 20. |

44. A positive battery plate comprising a coating of a lead composition comprising:
lead
100-1000 ppm antimony
100-1000 ppm iron
and not more than the given amounts of the following elements, measured in ppm:

| | |
|---|---|
| Bi | 700 |
| Zn | 700 |
| Cd | 500 |
| Sn | 50 |
| Ni | 2 |
| Co | 2 |
| Cr | 4 |
| Mn | 1.5 |
| Cu | 5 |
| Ag | 66 |
| Se | 0.5 |
| Te | 0.15 |
| As | 4 |
| Ge | 10 |
| Tl | 12. |

45. A negative battery plate comprising a coating of a lead composition comprising:
lead
250-1000 ppm Bi
250-1000 ppm Zn
20-100 ppm Ag
and not more than 20 ppm antimony and not more than 30 ppm iron.

46. A negative battery plate comprising a coating of a lead composition comprising:
lead
250-1000 ppm Bi
250-1000 ppm Zn
20-100 ppm Ag
and not more than the given amounts of the following elements measure in ppm:

| | |
|---|---|
| Sb | 10 |
| Fe | 20 |
| Sn | 80 |
| Cd | 1000 |
| Ni | 10 |
| Co | 10 |
| Cr | 15 |
| Mn | 5 |
| Cu | 20 |
| Se | 3 |
| Te | 5 |
| As | 20 |
| Ge | 250 |
| Tl | 20 |

47. A negative battery plate comprising a coating of a lead composition comprising:
lead
250-700 ppm Bi
250-1000 ppm Zn
40-66 ppm Ag
and not more than the given amounts of the following elements measure in ppm:

| | |
|---|---|
| Sb | 2 |
| Fe | 5 |
| Sn | 50 |
| Cd | 500 |
| Ni | 2 |
| Co | 2 |
| Cr | 4 |
| Mn | 1.5 |
| Cu | 5 |
| Se | 0.5 |
| Te | 0.15 |
| As | 4 |
| Ge | 10 |
| Tl | 12 |

48. A battery comprising at least one positive plate with a coating comprising:
lead
100-1000 ppm antimony
100-1000 ppm iron
and at least one negative plate with a coating comprising:
lead
250-1000 ppm bismuth
250-1000 ppm zinc
20-100 ppm silver
and not more than 20 ppm antimony and not more than 30 ppm iron.

49. A battery comprising at least one positive plate with a coating comprising:
lead
100-1000 ppm antimony
100-1000 ppm iron;
and not more than the given amounts of the following elements, measured in ppm:

| | |
|---|---|
| Bi | 1000 |
| Zn | 1000 |
| Cd | 1000 |
| Sn | 80 |
| Ni | 10 |
| Co | 10 |
| Cr | 15 |
| Mn | 5 |
| Cu | 20 |
| Ag | 100 |
| Se | 3 |
| Te | 5 |
| As | 20 |
| Ge | 250 |
| Tl | 20. |

and at least one negative plate with a coating comprising:
lead;
250-1000 ppm Bi
250-1000 ppm Zn
20-100 ppm Ag
and not more than the given amounts of the following elements measure in ppm:

| | |
|---|---|
| Sb | 10 |
| Fe | 20 |
| Sn | 80 |
| Cd | 1000 |
| Ni | 10 |
| Co | 10 |
| Cr | 15 |
| Mn | 5 |
| Cu | 20 |
| Se | 3 |
| Te | 5 |
| As | 20 |
| Ge | 250 |
| Tl | 20 |

50. A method for monitoring the level of undesirable elements in a lead composition, comprising the steps of:
(e) selecting maximum acceptable levels for the elements cobalt, chromium, manganese, selenium, tellurium, germanium and thallium in a lead composition;
(f) testing the level of said elements in a lead composition;
(g) evaluating the results of the test to determine whether the levels of the elements are within the selected maximum acceptable levels; and
(h) optionally modifying the lead composition to bring the level of any of the elements that are outside the maximum acceptable levels within the maximum acceptable levels.

51. The method of claim 50, wherein step (b) comprises testing the level of said elements using inductively coupled plasma atomic emission spectroscopy.

52. The method of claim 50 further comprising the steps of
selecting the required levels or maximum acceptable levels of the elements tin, bismuth, zinc, cadmium, nickel, antimony, iron, copper, silver and arsenic in a lead composition;
testing the level of these elements;
evaluating the results of the test to determine whether the levels of the elements are within the required levels or maximum acceptable levels; and
optionally modifying the lead composition to bring the level of any of the elements that are outside the required levels or maximum acceptable levels within these levels.
